(19) United States
(12) Patent Application Publication
(10) Pub. No.: US 2018/0181876 A1
(43) Pub. Date: Jun. 28, 2018

(54) UNSUPERVISED MACHINE LEARNING TO MANAGE AQUATIC RESOURCES

(71) Applicant: Intel Corporation, Santa Clara, CA (US)

(72) Inventors: Keenan Zhuo, Beaverton, OR (US); Suraj Sindia, Hillsboro, OR (US); Ricardo Ascazubi, Portland, OR (US); Balkaran Gill, Cornelius, OR (US); Clark VanDam, Hillsboro, OR (US)

(73) Assignee: Intel Corporation, Santa Clara, CA (US)

(21) Appl. No.: 15/388,097

(22) Filed: Dec. 22, 2016

(51) Int. Cl. G06N 99/00; G06N 5/04

(52) U.S. Cl. CPC G06N 99/005; G06N 5/04

(57) ABSTRACT

Various implementations provide an aquatic conditions optimization management system accesses aquatic sensor data generated by one or more aquatic sensors, identifies a collection of aquatic data that includes data generated by and collected from the aquatic sensor(s), generates a set of cross-correlation matrices based on the collection of aquatic data, executes a set of unsupervised machine learning algorithms using the set of cross-correlation matrices, and determines one or more optimum conditions for one or more aquatic resources based on the executed set of unsupervised machine learning algorithms. The optimum condition(s) may be communicated to one or more individuals and may include one or more corrective actions to improve one or more of the aquatic resources.

### TECHNICAL FIELD

This disclosure relates in general to the field of computer systems and, more particularly, to using machine learning in machine-to-machine systems.

### BACKGROUND

The Internet has enabled interconnection of different computer networks all over the world. While previously, Internet-connectivity was limited to conventional general purpose computing systems, ever increasing numbers and types of products are being redesigned to accommodate connectivity with other devices over computer networks, including the Internet. For example, smart phones, tablet computers, wearables, and other mobile computing devices have become very popular, even supplanting larger, more traditional general purpose computing devices, such as traditional desktop computers, in recent years. Increasingly, tasks traditionally performed on general purpose computers are performed using mobile computing devices with smaller form factors and more constrained feature sets and operating systems. Further, traditional appliances and devices are becoming “smarter” as they are ubiquitous and equipped with functionality to connect to or consume content from the Internet. For instance, devices, such as televisions, gaming systems, household appliances, thermostats, automobiles, watches, have been outfitted with network adapters to allow the devices to connect with the Internet (or another device) either directly or through a connection with another computer connected to the network. Additionally, this increasing universe of interconnected devices has also facilitated an increase in computer-controlled sensors that are likewise interconnected and collecting new and large sets of data. The interconnection of an increasingly large number of devices, or “things,” is believed to foreshadow an era of advanced automation and interconnectivity, referred to, sometimes, as the Internet of Things (IoT).

### BRIEF DESCRIPTION OF THE DRAWINGS

FIG. 1A illustrates an embodiment of a system including multiple sensor devices and an example management system.

FIG. 1B illustrates an embodiment of an example cloud computing network.

FIG. 2 illustrates an embodiment of a system including an example management system.

FIGS. 3A-3D are simplified graphs illustrating examples of various ensembles of aquatic sensor data.

FIG. 4 is a simplified diagram illustrating an example epoch cross-correlation matrix.

FIG. 5 is a simplified diagram illustrating example outputs related to the health of one or more aquatic resources.

FIG. 6 illustrates an example system including multiple sensor devices deployed in multiple aquatic resources.

FIG. 7 illustrates an example flow diagram of an aquatic resource management application.

FIG. 8 a simplified block diagram illustrating an example device to manage one or more aquatic resources.

FIG. 9 illustrates simple map 900 that illustrates a geographic region including indications of health for multiple aquatic resources.

FIG. 10 is a flowchart illustrating an example method to determine one or more optimal conditions for one or more aquatic resources.

FIG. 11 is flowchart illustrating an example method to determine one or more levels of health for one or more aquatic resources.

FIG. 12 is a block diagram of an exemplary processor in accordance with one embodiment.

FIG. 13 is a block diagram of an exemplary computing system in accordance with one embodiment.

Like reference numbers and designations in the various drawings indicate like elements.

### DETAILED DESCRIPTION OF EXAMPLE EMBODIMENTS

Aquatic health in natural and artificial aquatic resources (e.g., oceans, seas, ponds, lakes, streams, rivers, fisheries, pools, aquariums, fountains, etc.) is critically dependent on water quality, as measured by the balance of various organic and inorganic chemicals and chemical compounds in the water. If there is an imbalance in one of the many constituent elements and/or conditions in the water, the overall quality of aquatic life, potability, recreational use, commercial use, etc., can be degraded. Depending on the quantity and variety of elements and/or conditions that are imbalanced, severe implications (e.g., poor fish yield, lack of drinking water, contamination, toxicity, etc.) can result in temporary or permanent large-scale damage to aquatic life, humans, the aquatic environment overall, and/or the environment and/or fauna surrounding the aquatic resource.

With the proper information, humans are often capable of preventing adverse aquatic conditions and/or improving aquatic conditions through proper management measures. However, humans are often not aware what constitutes the optimal conditions for a particular aquatic resource. In fact, there are times when there is conflicting data or information as to what actually constitutes optimal conditions for a particular aquatic resource or set of aquatic resources.

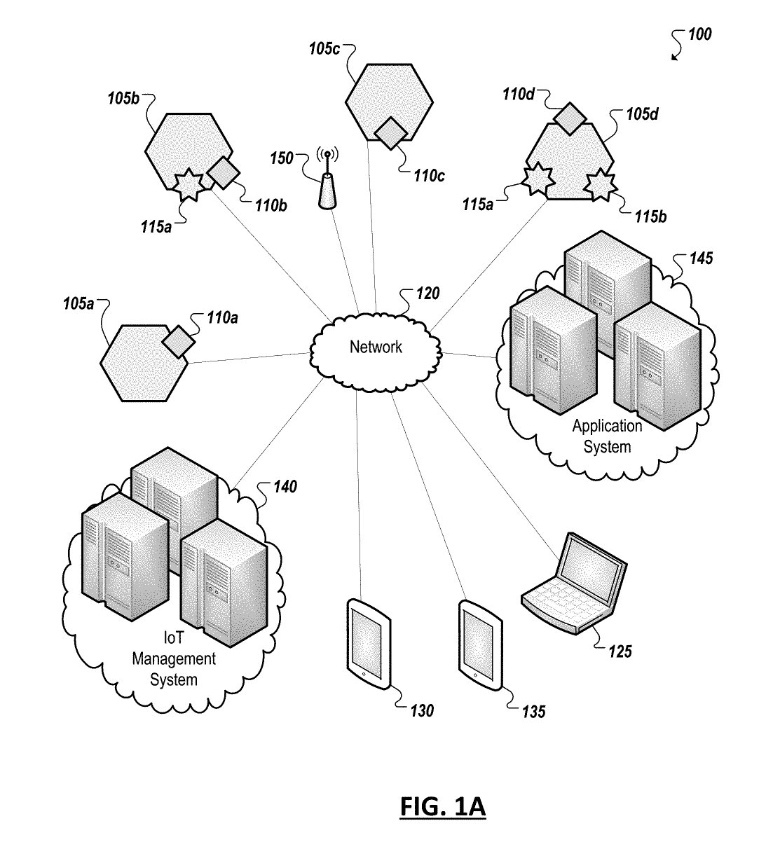

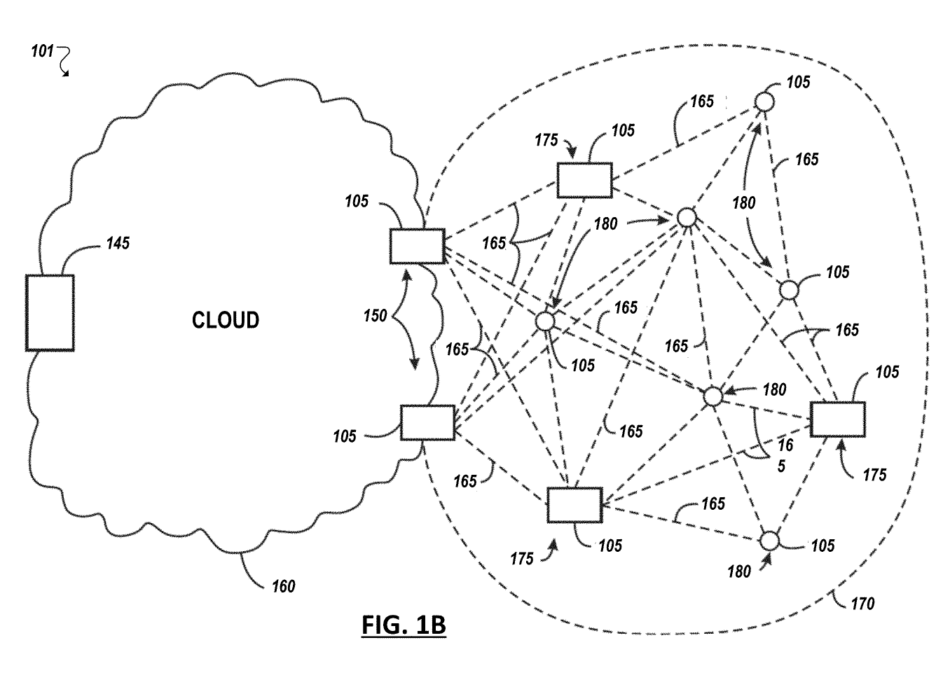

FIG. 1A is a block diagram illustrating a simplified representation of a system 100 that includes one or more devices 105a-105d deployed throughout one or more aquatic resources (e.g., one or more open and/or closed aquatic resources) to determine one or more optimized conditions for the aquatic resource(s). Each device 105a-105d may include a computer processor and/or communications module to allow each device 105a-105d to interoperate with one or more other devices (e.g., 125, 130, 135) or systems (e.g., 140, 145) in communication with each device 105a-105d via one or more networks 120 (e.g., a wired and/or wireless network). Each device 105a-105d can further include one or more instances of various types of aquatic sensors (e.g., 110a-110d), actuators (e.g., 115a-115b), storage, power, computer processing, and communication functionality which can be leveraged and utilized (e.g., by other devices or software) within a machine-to-machine, or Internet of Things (IoT) system or application. In some cases, inter-device communication and even deployment of an IoT application may be facilitated by one or more gateway devices (e.g., 150) through which one or more of the devices 105a-105d communicate and gain access to the other device(s) 125, 130, 135 and/or system(s) 140, 145 via the one or more networks 120.

Aquatic sensors (e.g., 110a-110d), or sensor assets, are capable of detecting, measuring, and generating aquatic sensor data describing characteristics of the aquatic environment in which they reside, are mounted, submerged, or are otherwise in contact with. For instance, a given aquatic sensor 110a-110d may be configured to detect one or more respective characteristics such as movement (e.g., tidal, flow rate, etc.), temperature, salinity, pH, specific chemicals, or specific chemical compounds, among several other examples. Indeed, aquatic sensors 110a-110d, as described herein, anticipate the development of a potentially limitless universe of various aquatic sensors, each designed to and capable of detecting, and generating corresponding aquatic sensor data for, new and known aquatic characteristics or conditions.

Actuators 115a-115b can allow each device 105a-105d to perform some kind of action to affect its environment. For instance, one or more of the devices 105a-105d can include one or more respective actuators 115a-115b that accepts an input and performs its respective action in response thereto. Actuators 115a-115b can include controllers to activate additional functionality, such as an actuator (e.g., 115a) to selectively toggle the power or operation of an alarm, camera (or other sensors), heating, cooling, lighting, and/or the like example functions.

In some implementations, aquatic sensors 110a-110d provided on devices 105a-105d (and actuators 115a-115b when provided with one or more devices 105) can be assets incorporated in and/or forming an Internet of Things (IoT) or machine-to-machine (M2M) system. IoT systems can refer to new or improved ad-hoc systems and networks composed of multiple different devices interoperating and synergizing to deliver one or more results or deliverables. Such ad-hoc systems are emerging as more and more products and equipment evolve to become “smart” in that they are controlled or monitored by computing processors and provided with facilities to communicate, through computer-implemented mechanisms, with other computing devices (and products having network communication capabilities). For instance, IoT systems can include networks built from sensors and communication modules integrated in or attached to “things” such as equipment, toys, tools, vehicles, etc. and even living things (e.g., plants, animals, humans, etc.). In some instances, an IoT system can develop organically or unexpectedly, with a collection of sensors monitoring a variety of things and related environments and interconnecting with data analytics systems and/or systems controlling one or more other smart devices to enable various use cases and application, including previously unknown use cases. Further, IoT systems can be formed from devices that hitherto had no contact with each other, with the system being composed and automatically configured spontaneously or on the fly (e.g., in accordance with an IoT application defining or controlling the interactions). Further, IoT systems can often be composed of a complex and diverse collection of connected devices (e.g., 105a-105d), such as devices sourced or controlled by varied groups of entities and employing varied hardware, operating systems, software applications, and technologies. In some cases, gateway 150 can be provided to localize a particular IoT system, with the gateway 150 able to detect nearby devices (e.g., devices 105a-d) and deploy (e.g., in an automated, impromptu manner) an instance of a particular IoT application by orchestrating configuration of these detected devices to satisfy requirements of the particular IoT application, among other examples.

Facilitating the successful interoperability of such diverse systems is, among other example considerations, an important issue when building or defining an IoT system in an aquatic environment. Software applications can be developed to govern how a collection of IoT devices can interact to achieve a particular goal or service. In some cases, the IoT devices may not have been originally built or intended to participate in such a service or in cooperation with one or more other types of IoT devices. Indeed, part of the promise of the Internet of Things is that innovators in many fields will dream up new applications involving diverse groupings of the IoT devices as such devices become more commonplace and new “smart” or “connected” devices emerge. However, the act of programming, or coding, such IoT applications may be unfamiliar to many of these potential innovators, thereby limiting the ability of these new applications to be developed and come to market, among other examples and issues.

As shown in the example of FIG. 1A, multiple devices 105a-105d can be provided from which one or more IoT application deployments to manage aquatic resources can be built. For instance, each device 105a-105d can be a different type of aquatic senor or sensing device, including such examples as, a thermometer, a pH sensor, a motion sensor (e.g., to measure tides, flow rate, etc.), a salinity sensor, a sensor to detect specific chemical and/or chemical compound, and the like examples in the aquatic resource in which each device 105a-105d is deployed. Some devices 105a-105d may be statically located, such as a device mounted to a dock, pier, buoy, oil rig, rock, tree, bottom of the aquatic resource, or other fixed/static man-made or natural structure. Other devices 105a-105d may be mobile, such as an aquatic sensor provisioned in the interior or exterior of an aquatic vehicle (e.g., boats, ships, submarines, etc.) or wearable devices worn by active human or animal users, among other examples. Indeed, it may be desired that some aquatic sensors move within an aquatic environment and applications can be built around use cases involving a moving subject or changing aquatic environment using such devices 105a-105d, including use cases involving both moving and static devices 105a-105d, among other examples.

Continuing with the example of FIG. 1A, software-based IoT management platforms can be provided to allow developers and end users to build and configure IoT aquatic resource management applications and systems for use. An IoT for an aquatic resource management application can provide software support to organize and manage the operation of a set of IoT aquatic devices (e.g., devices 105a-105d, aquatic sensors 110a-110d, etc.) for a particular purpose or use case. In some cases, an IoT for an aquatic resource management application can be in communication with an application on an operating system of a user computing device (e.g., 125), a mobile app for execution on a smart phone, tablet, smart watch, or other mobile device (e.g., 130, 135), a remote server, and/or gateway device (e.g., 150). In some cases, the aquatic resource management application can have or make use of an application management utility allowing users to configure settings and policies to govern how the set devices 105a-105d are to operate within the context of the aquatic IoT application. A management utility can also be used to orchestrate the deployment of a particular instance of an aquatic IoT application, including the automated selection and configuration of devices (and their assets) that are to be used with the application.

In some cases, an IoT management application may be provided (e.g., on a gateway, user device, or cloud-based server, etc.), which can manage potentially multiple different IoT applications or systems. For instance, an IoT aquatic resource management application or system, may be hosted on a single system, such as a single server system (e.g., 140), a single end-user device (e.g., 125, 130, 135), or a single gateway device (e.g., 150), among other examples. Alternatively, an IoT aquatic resource management system, or other system, may be implemented to be distributed across multiple hosting devices (e.g., 125, 130, 135, 140, 150, etc.).

As noted above, IoT aquatic resource management applications may be localized, such that a service is implemented utilizing an IoT aquatic resource management system (e.g., a plurality of devices 105a-105d) within a specific aquatic resource (e.g., lake, stream, river, ocean, pond, pool, aquarium, etc.). In some instances, devices 105a-105d may connect to one or more gateway devices 150 on which a portion of management functionality (e.g., as shared with or supported by management system 140) and a portion of application service functionality (e.g., as shared with or supported by application system 145) reside. Service logic and configuration data may be pushed (or pulled) to the gateway device 150 and used to configure a set of devices (e.g., 105a-105d, 130, 135, etc.) within range or proximity of the gateway device 150 to allow the set of devices to implement a particular service within that location. Likewise, aquatic condition data (e.g., 275) generated by one or more aquatic sensors 110 may be distributed (e.g., to or through a gateway 150) for local consumption, among other examples. A gateway device 150 may be implemented as a dedicated gateway element, or may be a multi-purpose or general purpose device, such as another IoT device (similar to devices 105a-105d) or user device (e.g., 125, 130, 135) that itself may include sensors and/or actuators to perform tasks within an IoT aquatic resource management system, among other examples.

In some cases, IoT aquatic resource management systems can interface (through a corresponding IoT management system or application or one or more of the participating IoT devices) with remote services, such as data storage, information services (e.g., media services, weather services), geolocation services, and computational services (e.g., data analytics, search, diagnostics, etc.) hosted in cloud-based and other remote systems (e.g., 140, 145). For instance, an IoT aquatic resource management system can connect (e.g., directly or through a gateway 150) to a remote service (e.g., 145) over one or more networks 120. In some cases, the remote service can, itself, be considered an asset of an IoT application. Data received by a remotely-hosted service can be consumed by the governing IoT aquatic resource management application and/or one or more of the component IoT devices (e.g., devices 105a-105d) to cause one or more results or actions to be performed, among other examples. The one or more networks (e.g., 120) can facilitate communication between devices (e.g., 105a-d), end user devices (e.g., 123, 130, 135), gateways (e.g., 150), and other systems (e.g., 140, 145) utilized to implement and manage IoT aquatic resource management applications in an environment. Such networks can include wired and/or wireless local networks, public networks, wide area networks, broadband cellular networks, the Internet, and the like.

In general, “servers,” “clients,” “computing devices,” “network elements,” “hosts,” “system-type system entities,” “user devices,” “gateways,” “IoT devices,” “sensor devices,” and “systems” (e.g., 105a-105d, 125, 130, 135, 140, 145, 150, etc.) in example computing environment 100, can include electronic computing devices operable to receive, transmit, process, store, or manage data and information associated with the computing environment 100. As used in this document, the term “computer,” “processor,” “processor device,” or “processing device” is intended to encompass any suitable processing apparatus. For example, elements shown as single devices within the computing environment 100 may be implemented using a plurality of computing devices and processors, such as server pools including multiple server computers. Further, any, all, or some of the computing devices may be adapted to execute any operating system, including Linux, UNIX, Microsoft Windows, Apple OS, Apple iOS, Google Android, Windows Server, etc., as well as virtual machines adapted to virtualize execution of a particular operating system, including customized and proprietary operating systems.

While FIG. 1A is described as containing or being associated with a plurality of elements, not all elements illustrated within computing environment 100 of FIG. 1A may be utilized in each alternative implementation of the present disclosure. Additionally, one or more of the elements described in connection with the examples of FIG. 1A may be located external to computing environment 100, while in other instances, certain elements may be included within or as a portion of one or more of the other described elements, as well as other elements not described in the illustrated implementation. Further, certain elements illustrated in FIG. 1A may be combined with other components, as well as used for alternative or additional purposes in addition to those purposes described herein.

As noted above, a collection of devices, or endpoints, may participate in Internet-of-things (IoT) networking, which may utilize wireless local area networks (WLAN), such as those standardized under IEEE 802.11 family of standards, home-area networks such as those standardized under the Zigbee Alliance, personal-area networks such as those standardized by the Bluetooth Special Interest Group, cellular data networks, such as those standardized by the Third-Generation Partnership Project (3GPP), and other types of networks, having wireless, or wired, connectivity. For example, an endpoint device may also achieve connectivity to a secure domain through a bus interface, such as a universal serial bus (USB)-type connection, a High-Definition Multimedia Interface (HDMI), or the like.

As shown in the simplified block diagram 101 of FIG. 1B, in some instances, a cloud computing network, or cloud, in communication with a mesh network of IoT devices (e.g., devices 105a-105d), which may be termed a “fog,” may be operating at the edge of the cloud. To simplify the diagram, not every IoT device (e.g., devices 105a-105d) is/are labeled.

The fog 170 may be considered to be a massively interconnected network wherein a number of IoT devices (e.g., devices 105a-105d) are in communications with each other, for example, by radio links 165. This may be performed using the open interconnect consortium (OIC) standard specification 1.0 released by the Open Connectivity Foundation™ (OCF) on Dec. 23, 2015. This standard allows devices to discover each other and establish communications for interconnects. Other interconnection protocols may also be used, including, for example, the optimized link state routing (OLSR) Protocol, or the better approach to mobile ad-hoc networking (B.A.T.M.A.N.), among others.

Three types of IoT devices are shown in this example, devices 105a-105d, gateways 150, and data aggregators 175, although any combination of IoT devices and functionality may be used. The gateways 150 may be edge devices that provide communications between the cloud 160 and the fog 170, and may also function as charging and locating devices for the devices 105a-105d. The data aggregators 175 may provide charging for devices 105a-105d and/or may also locate devices 105a-105d. The locations, charging alerts, battery alerts, and other data, or both may be passed along to the cloud 160 through the gateways 150. As described herein, devices 105a-105d may provide power, location services, or both to other devices or items.

Communications from each device 105a-105d may be passed along the most convenient path between any of the devices 105a-105d to reach the gateways 150. In these networks, the number of interconnections provide substantial redundancy, allowing communications to be maintained, even with the loss of a number of devices 105a-105d.

The fog 170 of these devices 105a-105d may be presented to devices in the cloud 160, such as a server 145, as a single device located at the edge of the cloud 160, e.g., a fog 170 device. In this example, the alerts coming from the fog 170 device may be sent without being identified as coming from a specific device 105a-105d within the fog 170. For example, an alert may indicate that an aquatic sensor (e.g., 110a) in a device (e.g., 105a) needs to be returned for charging and the location of the aquatic sensor, without identifying any specific data aggregator 175 that sent the alert.

In some examples, devices 105a-105d may be configured using an imperative programming style, e.g., with each device 105a-105d having a specific function. However, the devices 105a-105d forming the fog 170 may be configured in a declarative programming style, allowing the devices 105a-105d to reconfigure their operations and determine needed resources in response to conditions, queries, and device failures. Corresponding service logic may be provided to dictate how devices may be configured to generate ad hoc assemblies of devices, including assemblies of devices which function logically as a single device, among other examples. For example, a query from a user located at a server 145 about the location of a sensor 180 may result in the fog 170 device selecting the device(s) 105a-105d, such as particular data aggregators 175, needed to answer the query. If the sensors 180 are providing power to devices 105a-105d, sensors associated with the sensors 180, such as power demand, temperature, and the like, may be used in concert with aquatic sensors 110a-110d on devices 105a-105d, or other devices, to answer a query. In this example, devices 105a-105d in the fog 170 may select the sensors on a particular sensor 180 based on the query, such as adding data from power sensors or temperature sensors. Further, if some of the devices 105a-105d are not operational, for example, if a data aggregator 175 has failed, other devices 105a-105d in the fog 170 may provide substitute, allowing locations to be determined.

Further, the fog 170 may divide itself into smaller units based on the relative physical locations of the sensors 180 and data aggregators 175. In this example, the communications for a sensor 180 that has been instantiated in one portion of the fog 170 may be passed along to devices 105a-105d along the path of movement of the sensor 180. Further, if the sensor 180 is moved from one location to another location that is in a different region of the fog 170, different data aggregators 175 may be identified as charging stations for the sensor 180.

As an example, if a sensor 180 is used to power a device (e.g., 105a) in a lake, the device will be moved from an initial location, such as a bay, to one or more other locations in the lake, which may be a few hundred feet to several thousands of feet from the initial location. If the entire lake is included in a single fog 170 charging structure, as the portable device 105 moves, data may be exchanged between data aggregators 175 that includes the alert and location functions for the sensor 180, e.g., the instantiation information for the sensor 180. Thus, if a battery alert for the sensor 180 indicates that it needs to be charged, the fog 170 may indicate a closest data aggregator 175 that has a fully charged sensor 180 ready for exchange with the sensor (e.g., 110a) in the portable device.

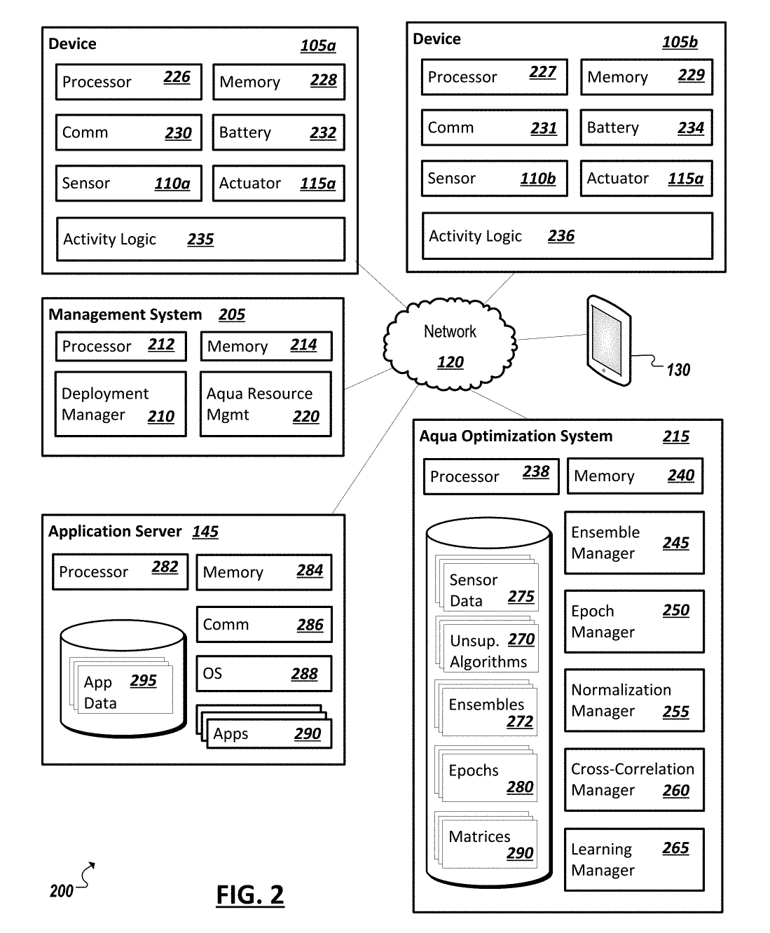

With reference now to FIG. 2, systems, such as those shown and illustrated herein, can include machine logic implemented in hardware and/or software to implement the systems and solutions to determine one or more optimized conditions for an aquatic region including one or more bodies of water or aquatic resources. For instance, FIG. 2 shows a simplified block diagram illustrating a system 200 including multiple devices (e.g., devices 105a, 105b) with corresponding aquatic sensors (e.g., 110a, 110b), respectively (and one or more actuators 115 when included) capable of being used in a variety of aquatic resources and detecting/sensing a variety of aquatic conditions. In the example of FIG. 2, a management system 205 is provided with deployment manager logic 210 (implemented in hardware and/or software) to detect assets within an aquatic resource and identify opportunities to deploy devices (e.g., 105a, 105b) to utilize aquatic sensors (e.g., 110a, 110b). Deployment can involve automatically identifying and configuring sensors (e.g., 110a, 110b) to participate in a new or ongoing aquatic condition management application deployment.

During deployment, or runtime operation of an aquatic condition management application, one or more conditions in any one of the aquatic resources in which devices 105a-105d and their respective aquatic sensors (e.g., 110a, 110b), respectively, are deployed in a manner that enables them to be detected by an aquatic condition management application. Accordingly, a system 200 may be provided with functionality to effectively detect and manage one or more conditions within one or more aquatic resources.

In one example, one or more devices (e.g., 105a, 105b, 140, 145, 150, etc.) within a WSN or IoT aquatic resource management system (e.g., 200) may work in concert to detect current aquatic conditions, determine one or more optimal conditions for one or more aquatic resources, and provide one or more correct actions, as needed. Some devices (e.g., 105a, 105b) may include functionality to detect, in real time, aquatic conditions sensed or experienced by one or more of aquatic sensor (e.g., 110a, 110b) within the IoT aquatic resource management system. The aquatic conditions may be detected and, in response thereto, aquatic condition data (e.g., 275) can be generated by the aquatic sensor(s) (e.g., 110a, 110b). The aquatic condition data can describe, for example, water movement (e.g., tidal, flow rate, etc.), temperature, salinity, pH, specific chemicals, or specific chemical compounds, among several other examples.

In the particular example of FIG. 2, each device 105a, 105b may include one or more data processing apparatus (or “processors”) (e.g., 226, 227), one or more memory elements (e.g., 228, 229), one or more communications modules (e.g., 230, 231), a battery (e.g., 232, 233) or other power source (e.g., a solar cell, etc.), among other components. Each device (e.g., 105a, 105b) can possess hardware, sensors (e.g., 110a, 110b), actuator(s) (e.g., 115), and other logic (e.g., 235, 236) to realize the intended function(s) of a device 105 (including operation of the respective sensors and actuators). In some cases, each device (e.g., 105a, 105b) may be provided with such assets as one or more sensors of the same or varying types. For example, sensor 110a (in device 105a) may be a thermometer, sensor 110b (in device 105b) may be a pH sensor, another sensor (in a same or different device) may be an oxygen sensor, another sensor may be a (dissolved) carbon dioxide sensor, among other examples of aquatic sensors. In another example, each of or a subset of sensors (e.g., 110a, 110b) may include two or more sensing capabilities. In yet another example, at least two of sensors (e.g., 110a, 110b) include different sensing capabilities.

Types of actuators 115 may vary and can include computing assets (e.g., through a respective processor and/or software logic), security features, data storage assets, and other resources. Communication modules (e.g., 230, 231) may also be utilized as communication assets within some deployments and may include hardware and/or software to facilitate the device's communication over one or more networks (e.g., 120), utilizing one or more technologies (e.g., WiFi, Bluetooth, Near Field Communications, Zigbee, Ethernet, etc.), with other systems and devices.

In some instances, detection of the various aquatic conditions may be provided by a gateway device 150 or a management system 205, which has access to the aquatic condition data (e.g., 275) generated by aquatic sensors (e.g., 110a, 110b) in each device (e.g., 105a, 105b) in a collection of devices in one or more aquatic environments. In the particular example of FIG. 2, an example management system 205 may include one or more processors (e.g., 212), one or more memory elements (e.g., 214), and one or more communication modules incorporating hardware and logic to allow the management system 205 to communicate over one or more networks (e.g., 120) with other systems and devices (e.g., 105a, 105b, 130, 145, 215, etc.). The deployment manager 210 (and other components) may be implemented utilizing code executable by the processor 212 to manage the automated deployment of a local IoT aquatic resource management system. Additional components may also be provided to assist with aquatic condition detection and reporting in one or more IoT aquatic resource management application deployments (including deployments not directly assisted by the management system 205). For instance, a management system 205 may include aquatic resource management logic 220, among other example components and features.

As noted above, an aquatic resource management logic 220 may be provided to access aquatic condition optimization system 215. Aquatic resource management logic 220 can determine one or more levels of aquatic health for one or more aquatic resources based on outputs (e.g., calculated optimal conditions) received from aquatic condition optimization system 215. The aquatic resource management logic 220 may additionally log the reported outputs and may determine reporting events or alerts based on the receipt of the output(s) determined to be one or more undesirable aquatic conditions. For instance, aquatic resource management logic 220 may include functionality for applying a threshold or heuristic to the output(s) to determine a state of health or a level of threat for one or more aquatic resources based on, for example, a comparison of an optimal condition and a current condition for one or more conditions in one or more aquatic resources. The aquatic resource management logic 220 may additionally trigger service tickets, alerts, and/or other actions (e.g., corrective actions) based on the determined level of health for the aquatic resource(s).

In a particular implementation, aquatic resource management logic 220 determine five level of health (e.g., levels L1-L5), although a greater number or fewer number of level of health can be implemented. For example, one aquatic health level (e.g., L5) can represent a “normal” or stable aquatic condition and the remaining four aquatic health levels (e.g., L1-L4) can represent various degrees/stages of an adverse level of health for the one or more aquatic resources.

Each adverse level of aquatic health (e.g., levels L1-L4) can be associated with a set of actions (e.g., corrective actions) to improve the aquatic health of the aquatic resource(s). The set of actions may vary based on any number of factors including type(s) of anomalies in the water, geographic location, climate, season, size, water type (fresh or salt), elevation, open/closed system, and the like factors. One example set of actions corresponding to various levels of determined aquatic health is shown in Table 1 below. One or more backend services may communicate the service ticket, warning, and/or the set of actions to a user.

| Example | Example | |
|---|---|---|
| Risk Levels | Conditions | Example Corrective Actions |
| L1: | Drastic changes in | Calls/text messages placed to the |
| Crisis | one or more vital | owner, and the local law |
| | chemicals | enforcement. |
| | requiring | Summary of vital statistics to reflect |
| | immediate | the gravity of the situation through |
| | attention. | a targeted message or email to all |
| | Risk of spread to | stakeholders. |
| | more than one | |
| | aquatic body. | |
| L2: | One or more | Send notifications to the impacted |
| Grave | parameters, for | owner. |
| | example ammonia | Increase sampling frequency of |
| | level or | sensed parameters; temporarily |
| | temperature, are | reduce functionality until a certain |
| | significantly out of | manual intervention to restore the |
| | bounds: requires | conditions to normal is or lower risk |
| | deliberate | level is made. |
| | consideration and | |
| | action. | |
| L3: | Some parameters | Temporarily kick in autonomous |
| Tolerable | have changed, but | function until a manual intervention |
| | are still within their | is performed. |
| | tolerance band. | Small changes are controlled at a |
| | | certain point. |
| L4: | There is a | Small changes that are perceivable |
| Perceivable | recognizable | for small durations are ignored. |
| | change in one or | Perceived changes that exceed |
| | more parameters | certain length of time are flagged |
| | that does not | as tolerable. |
| | warrant any | A notification when perceivable |
| | immediate | change moves to a tolerable state |
| | attention. | is sent to the user. |
| L5: | Normal operation. | Continuously monitored free- |
| Normal | | running operation. |

In some cases, the management system 205 may be implemented on a dedicated physical system (e.g., separate from other devices in the IoT deployment). For instance, the management system 205 may be implemented on a gateway device 150 used to facilitate communication with and between multiple devices (e.g., 105a, 105b) within a particular location or region. In some instances, the management system 205 may be hosted at least in part on a user device (e.g., a personal computer or smartphone), including a user device that may itself be utilized in the deployment of a particular aquatic resource management application. Indeed, the management system 205 (and deployment manager 210 and aquatic resource management logic 220) may be implemented on multiple devices, with some functionality of the management system 205 hosted on one device and other functionality hosted on other devices. A management system 205 may, in some cases, be hosted partially or entirely remote from the environment in which the devices (e.g., 105a, 105b) are to be deployed. Indeed, a management system 205 may be implemented using one or more remote computing systems, such as cloud-based resources, that are remote from the devices, gateways, etc. utilized in a given aquatic resource management application.

An aquatic condition optimization system 215 may be provided to apply unsupervised machine learning algorithms (e.g., a Bayesian context mining algorithm, a support vector machine, etc.) to aquatic sensor data 275 generated by devices (e.g., 105a, 105b) in an IoT deployment to determine one or more optimal aquatic conditions for one or more aquatic resources based on one or more detected aquatic conditions (e.g., detected by one or more of the sensors on one or more devices). An example aquatic condition optimization system 215 may include one or more data processing apparatus (e.g., 238), one or more memory elements (e.g., 240) with code (implemented in hardware, firmware, and/or software) executable by the processor to implement an ensemble manager (e.g., 245), an epoch manager (e.g., 250), a normalization manager (e.g., 255), a cross-correlation manager (e.g., 260), a learning manager (e.g., 265), and an aquatic assessment manager (e.g., 270), among other examples and combinations of the foregoing.

In one example, aquatic sensor data 275 representing detected aquatic conditions may be directly received from the devices (e.g., 105a, 105b) implementing the sensors (e.g., 110a, 110b) or may be received from another aggregator of the aquatic sensor data 275 (e.g., management system 205, an IoT gateway (e.g., 150), etc.). The aquatic sensor data 275 may be continuously received, substantially continuously received, or received in predetermined intervals or time periods by aquatic condition optimization system 215

An ensemble manager (e.g., 245) may be provided in aquatic condition optimization system 215, which can be operable to allow a collection of aquatic conditions (e.g., movement (e.g., tidal, flow rate, etc.), temperature, salinity, pH, specific chemicals, or specific chemical compounds, among several other examples) to be selected as the basis in predicting optimal conditions for a particular body of water, aquatic resource, or aquatic region. In some implementations, a user may select the collection of different aquatic conditions for use in generating one or more raw data ensembles (e.g., 272) based on the aquatic sensor data 275 received by aquatic condition optimization system 215. In some cases, the ensemble manager 245 may self-identify the aquatic condition(s), for instance, by identifying two or more of the aquatic conditions in the set of aquatic conditions.

The ensemble manager 245, in an example, is capable of generating multiple raw data ensembles 272 from the received aquatic sensor data 275 (which represents the detected aquatic conditions) and each raw data ensemble 272 comprises raw aquatic data related to a pair of different aquatic conditions. For example, a raw data ensemble 272 may include raw pH data and raw salinity data, whereas other examples may include raw pH data and raw oxygen concentration data, or raw temperature data and raw carbon dioxide concentration data, among other examples.

In one implementation, an epoch manager 250 may sample the aquatic sensor data 275 in each raw data ensemble 272 at multiple sampling periods (T_{S}) to generate a sampled ensemble epoch 280 for each represented aquatic condition (i.e., one or more sampled ensemble epochs 280). A sampling period T_{S} may be any interval of time (e.g., 1 second, 1 minute, 1 hour, etc.) needed by a sensor 110 to detect and/or collect a particular aquatic condition for inclusion as at least a portion of aquatic sensor data 275. The amount of time that lapses between the first sampling period (T₁) and the last sampling period (Tₙ) define an epoch of time (T_{E}), which may include any number of predetermined sampling periods T_{S} or length of time. One example epoch of time T_{E} may include eight sampling periods (T₀ through T₇) of one second each covering a time interval of seven seconds.

An example normalization manager (e.g., 255) normalizes the sampled raw aquatic sensor data 275 in each sampled ensemble epoch 280 (i.e., the one or more sampled ensemble epochs 280) to generate a normalized ensemble epoch 285 for each sampled ensemble epoch 280 (i.e., one or more normalized ensemble epochs 285). The sampled raw aquatic sensor data may be normalized relative to the maximum value in each aquatic sensor data stream, which harmonizes data streams from various sensors 110 since each sensor 110 can have its own minimum and maximum frequency values for any given epoch of time T_{E}. Various implementations of normalization manager 255 limit the normalized values of the sampled raw aquatic sensor data 275 to a value between 0.0 and 1.0.

A cross-correlation manager 260, in one example, calculates a mutual cross-correlation value (e.g., r_{xy}) of each pair of normalized sampled raw aquatic sensor data 275 in each normalized ensemble epochs 285 (e.g., calculates multiple mutual cross-correlations) to generate a cross-correlation ensemble epoch (e.g., 287). An epoch cross-correlation matrix (e.g., 290) can be populated with the calculated mutual cross-correlation values by cross-correlation manager 260. To calculate the mutual cross-correlation of two different sensed aquatic condition parameters (e.g., x and y), the covariance c_{xy} between the aquatic condition parameters is found using equation (1) below:

$${c}_{xy} ( k ) = \{ \begin{matrix}\frac{1}{n} {\sum }_{t = 1}^{n - k} ( {x}_{t} - \overline{x} ) ( {y}_{t + k} - \overline{y} ) k = 0 , 1 , 2 , … \\ \frac{1}{n} {\sum }_{t = 1}^{n + k} ( {y}_{t} - \overline{y} ) ( {x}_{t - k} - \overline{x} ) k = 0 , - 1 , - 2 , …\end{matrix} ; \qquad Eq . ( 1 )$$

wherein, the mutual cross-correlation (r_{xy}) is found using equation (2), as follows:

$${r}_{xy} = \frac{{c}_{xy} ( k )}{{s}_{x} {s}_{y}} k = 0 , \pm 1 , \pm 2 , … ; \qquad Eq . ( 2 )$$

wherein, sₓ and s_{y} are defined as:

sₓ=\sqrt{cₓₓ(0)}

and

s_{y}=\sqrt{c_{yy}(0)} Eq (3).

Various implementations may limit each mutual cross-correlation value r_{xy} to a value between, for example, −1.0 and 1.0, among other example values and/or ranges of values. The cross-correlation manager 260 can calculate mutual cross correlation values for subsequent pairs of normalized sampled raw aquatic sensor data 275 in subsequent normalized ensemble epochs 285 and populate multiple epoch cross-correlation matrices 290 with the subsequently computed mutual cross-correlation values. That is, cross-correlation manager 260 can generate multiple epoch cross-correlation matrices 290 for aquatic sensor data 275 that is generated at different times and/or different aquatic locations (e.g., asynchronously generated).

One example of a learning manager (e.g., 265) can be a neural network-based unsupervised learning machine that is fed multiple epoch cross-correlation matrices 290 and determines a set of optimal conditions for one or more aquatic resources based thereon. In certain implementations, learning manager 265 can comprise advanced mathematical algorithms (e.g., 270) (e.g., Bayesian networks created by structure search using a Bayesian model score or approximation, linear classifiers, such as support vector machines (SVMs), and/or the like algorithms) that facilitate unsupervised learning.

As noted above, an aquatic resource management application may involve one or more backend services, such as provided by one or more application servers (e.g., 145). In one example, an application server 145 may include one or more data processing apparatus 282, one or more memory elements 284, and one or more communication modules 286 incorporating hardware and logic to allow the application server 145 to communicate over one or more networks (e.g., 120) (e.g., with a management system 205, IoT gateway 150, directly with a device (e.g., 105a, 105b, etc.). The application server 145 may further run an operating system 288 and one or more applications 290. The applications 290 may consume and/or generate various data 295 hosted at the application server 145 (or other data stores). Applications 290 may, in some cases, include service logic utilized during runtime and/or deployment of an aquatic resource management system (e.g., including devices 105a, 105b) or may be services that are consumed by elements of the service logic utilized in an aquatic resource management system deployment (e.g., and hosted on devices 105a, 105b, management system 205, user device 130, or other machines associated with an IoT aquatic resource management system's deployment. An application (e.g., 290) in one example may receive data generated by one or more sensor assets (e.g., 110a, 110b) of one or more devices (e.g., 105a, 105b) deployed in an IoT aquatic resource management system and apply logic embodied in one or more unsupervised algorithms 270 to generate results related to the health of an aquatic resource that may be presented in a report or graphical user interface (GUI) of a user device (e.g., 130). Such results may even be returned to one or more of the participating devices (e.g., 105a, 105b) for consumption by the deployed device (e.g., in connection with the triggering of an actuator asset of the device) during runtime of the IoT aquatic resource management system, among other, potentially limitless examples.

User devices (e.g., 130) may be utilized in a variety of ways within an IoT aquatic resource management application deployment, such as system 200. User devices 130 may possess management system functionality, functionality of an IoT aquatic resource management system, may be utilized to control or manage a particular IoT aquatic resource management application (e.g., through a UI of the IoT application provided on the device 130), or to provide other assets (e.g., sensor, actuator, computing, or storage) for use in a particular IoT aquatic resource management application deployment. In one example, a user device 130 may include a UI engine, which may be leveraged in a particular IoT aquatic resource management application deployment to provide one or more UIs for use by a user in connection with the deployment. A user device 130 may include one or more data processors, one or more memory elements, a communication module enabling communication with other systems using wireless and/or wireline network connections, and an operating system on which one or more applications may be run. A user device 130 may include one or more input devices, which may embody sensors implementing a touchscreen interface, keyboard, tracker ball, camera, or other mechanism through which user inputs may be captured. A user device 130 may also include one or more presentation devices (e.g., driven by corresponding actuators) to implement a graphical display, an audio presentation (e.g., speakers), a light output (e.g., of an integrated LED flashlight or camera flash), or vibration motor to output vibration-based signals, among other examples. Input devices and presentation devices, and computing resources of a user device (e.g., 130) may be utilized to fulfill UI requirements of a particular IoT aquatic resource management application, resulting in the deployment of a user device (e.g., 130) in connection with deployment of the particular IoT aquatic resource management application, among other example uses.

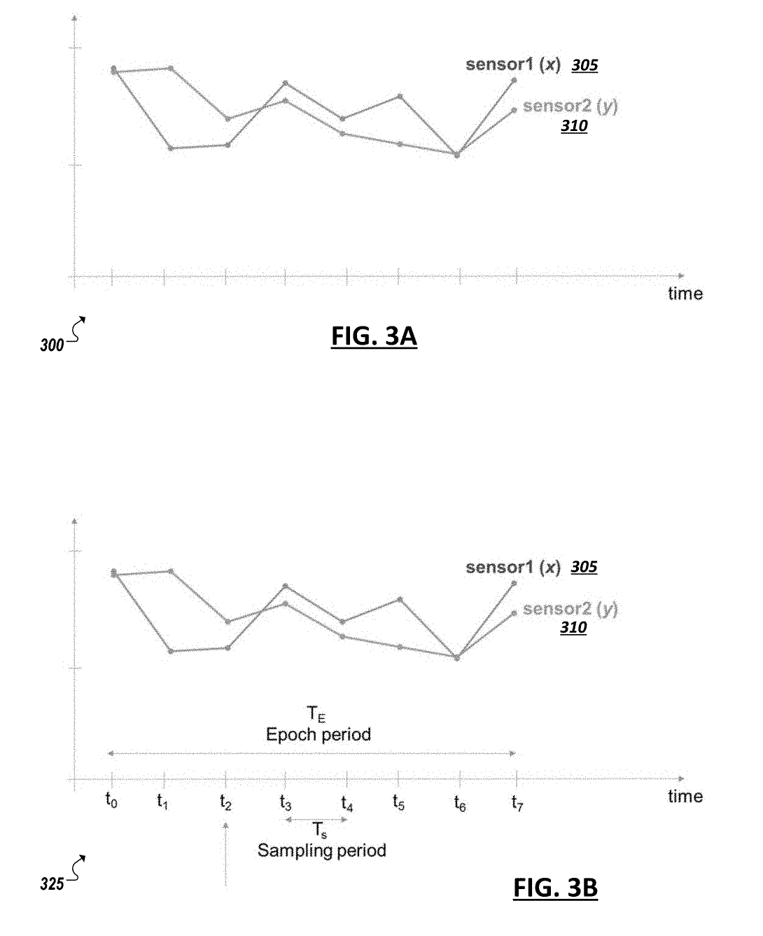

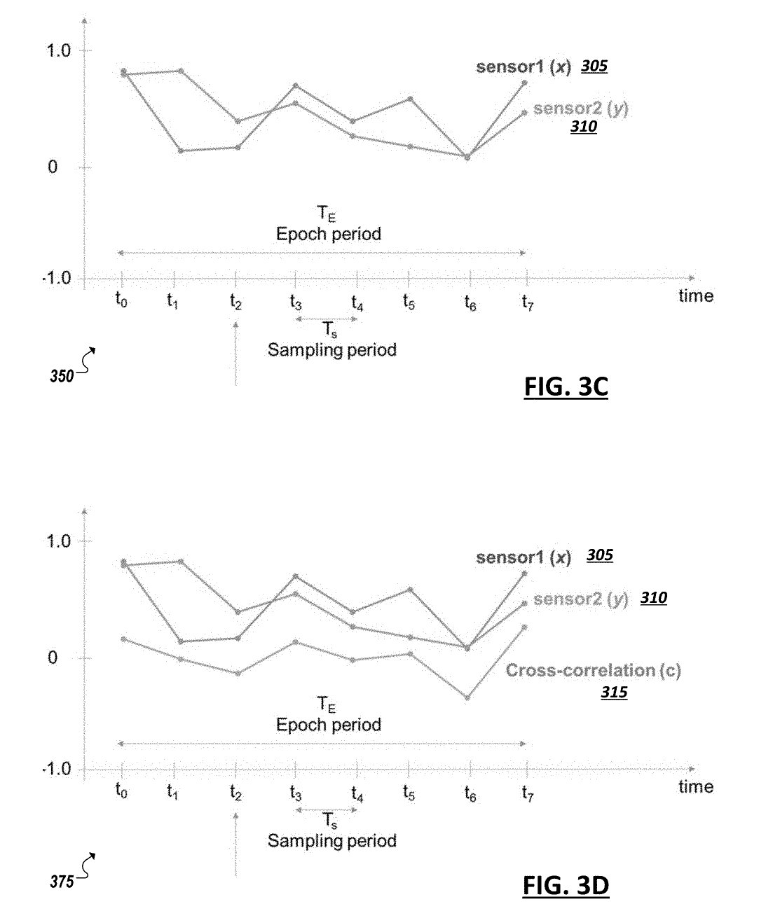

FIGS. 3A-3D are graphs (e.g., 300, 325, 350, and 375) showing examples of various ensembles (e.g., 272, 280, and 285) of aquatic sensor data (e.g., 275) collected from one or more sensors (e.g., 110). FIG. 3A illustrates a two-dimensional graph 300 of one example of an ensemble of raw aquatic sensor data (e.g., 272). Graph 300 is a representation of quantities of two different aquatic conditions (e.g., x and y, which may be pH and salinity, among other paired examples) detected over time. The y-axis represents the detected quantity of each aquatic condition detected by one or more sensors and the x-axis represents time. Aquatic sensor data representing a first aquatic condition can be shown as a line (e.g., 305) and aquatic sensor data representing a second (different) aquatic condition can be shown as a line (e.g., 310). The two different aquatic conditions are paired together to generate the raw aquatic sensor data ensemble 272 of the aquatic conditions for a process to determine a cross-correlation of the different aquatic conditions.

FIG. 3B illustrates a two-dimensional graph 325 of an example of a sampled ensemble epoch (e.g., 280) generated (e.g., by an epoch manager (e.g., 250)) from a corresponding raw aquatic sensor data ensemble (e.g., 272). A sampled ensemble epoch 280 is a representation of data samples of the paired aquatic sensor data from the two different aquatic conditions represented in a corresponding raw aquatic sensor data ensemble (e.g., 272) taken at one or more periodic sampling times (T_{S}). A sampling time T_{S} can be any predetermined quantity of time (e.g., one or more seconds, minutes, hours, days, etc., or portions thereof, among other examples) and multiple (i.e., two or more) sampling times T_{S} can be combined to define an epoch of time T_{E}. The y-axis represents the detected quantity of each aquatic condition detected by the sensor(s) (e.g., 105) and the x-axis represents the time over which the quantities were detected and subsequently sampled, incremented in accordance with a particular aquatic resource management application and/or determination of optimal aquatic conditions for the aquatic resource(s).

FIG. 3C illustrates a two-dimensional graph 350 of one example of a normalized ensemble epoch (e.g., 285) generated (e.g., by a normalization manager (e.g., 255)) from a corresponding sampled ensemble epoch (e.g., 280). The sampled raw aquatic sensor data in each sampled ensemble epoch 280 may be normalized relative to the maximum value in each aquatic sensor data stream, which harmonizes data streams from the various sensors (e.g., 110) since each sensor can have its own minimum and maximum frequency values for any given epoch of time T_{E}. The x-axis represents the time over which quantities of the aquatic conditions were detected and subsequently sampled and the y-axis represents the normalized value of each aquatic condition. Various implementations limit the normalized values of the sampled raw aquatic sensor data (e.g., 275) to a value between, for example, 0.0 and 1.0, among other example values and/or ranges of values.

FIG. 3D illustrates a two-dimensional graph 375 of an example of a cross-correlation ensemble epoch (e.g., 287) of mutual cross-correlation values (e.g., r_{xy}) calculated (e.g., by a cross-correlation manager (e.g., 260)) from a corresponding normalized ensemble epoch (e.g., 285). A set of mutual cross-correlation values r_{xy} for each pair of different sensed aquatic conditions can be represented by a line (e.g., 315) and can be calculated from the normalized samples of raw aquatic sensor data using equation (2), in which a covariance c_{xy} of the aquatic condition parameters (e.g., x, y) can be calculated using equation (1), and sₓ and s_{y} are defined in equation (3), each of which is discussed above with reference to FIG. 2. The x-axis represents the time over which quantities of the aquatic conditions were detected and subsequently sampled and the y-axis represents a set of mutual cross-correlation values of the pair of aquatic conditions. Various implementations may limit the mutual cross-correlation values to a value between, for example, −1.0 and 1.0, among other example values and/or ranges of values.

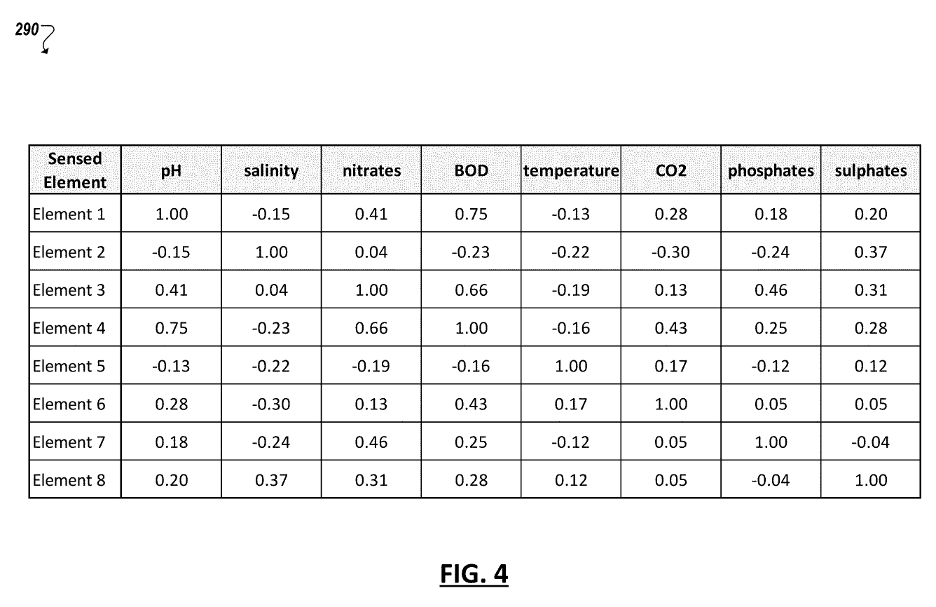

The mutual cross-correlation values r_{xy} in a cross-correlation ensemble epoch 287 can be used to populate an epoch cross-correlation matrix (e.g., 290), an example of which is illustrated in FIG. 4, among other examples. The border rows and columns of epoch cross-correlation matrix 290 can identify particular aquatic conditions (e.g., pH, salinity, nitrates, dissolved oxygen (O₂), temperature, dissolved carbon dioxide (CO₂), phosphates, and sulphates, among other examples) that are being measured to determine one or more optimal conditions for an aquatic resource. A box corresponding to each particular pair of different aquatic conditions is populated with the calculated mutual cross-correlation value r_{xy} for a particular pair of different aquatic conditions. Each box can be populated with the calculated mutual cross-correlation value r_{xy} for its associated particular pair of different aquatic conditions.

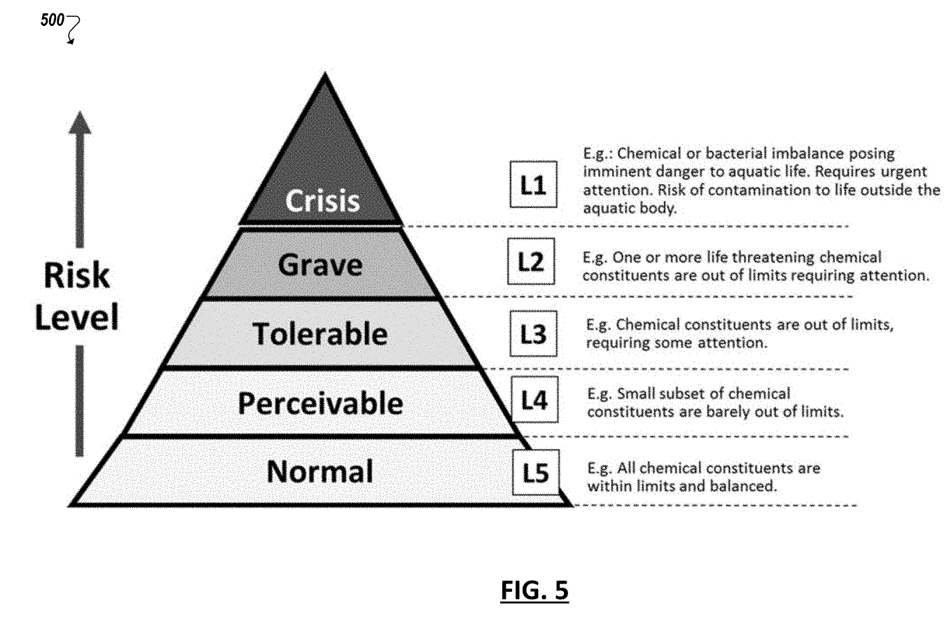

Referring to FIG. 5, a simplified diagram 500 representing example outputs (e.g., one or more levels of aquatic health or condition for an aquatic resource), among other example outputs (both individual outputs and/or a set of outputs), is illustrated. In an example illustrated in FIG. 4, five potential outputs or aquatic health levels (e.g., levels L1-L5) may be determined (e.g., by an aquatic resource management logic (e.g., 220)). One aquatic health level (e.g., L5) can represent a “normal” or stable aquatic condition and the remaining four aquatic health levels (e.g., L1-L4) can represent various degrees/stages of an adverse health condition or level of aquatic health for the one or more aquatic resources.

Each adverse level of aquatic health (e.g., levels L1-L4) can be associated with a description of one or more conditions defining a particular condition. For example, adverse level L4 can be defined as having “a small subset of chemical constituents that are barely out of normal limits,” level L3 can be defined as having “chemical constituents that are out of limits and require some attention,” level L2 can be defined as having one or more life threatening chemical constituents are out of limits and require attention,” and level L1 can be defined as having “a chemical or bacterial imbalance posing imminent danger to aquatic life and requires urgent attention because it poses a risk of contamination to life outside of the aquatic resource,” among other examples of each level and/or the group of health levels as a whole.

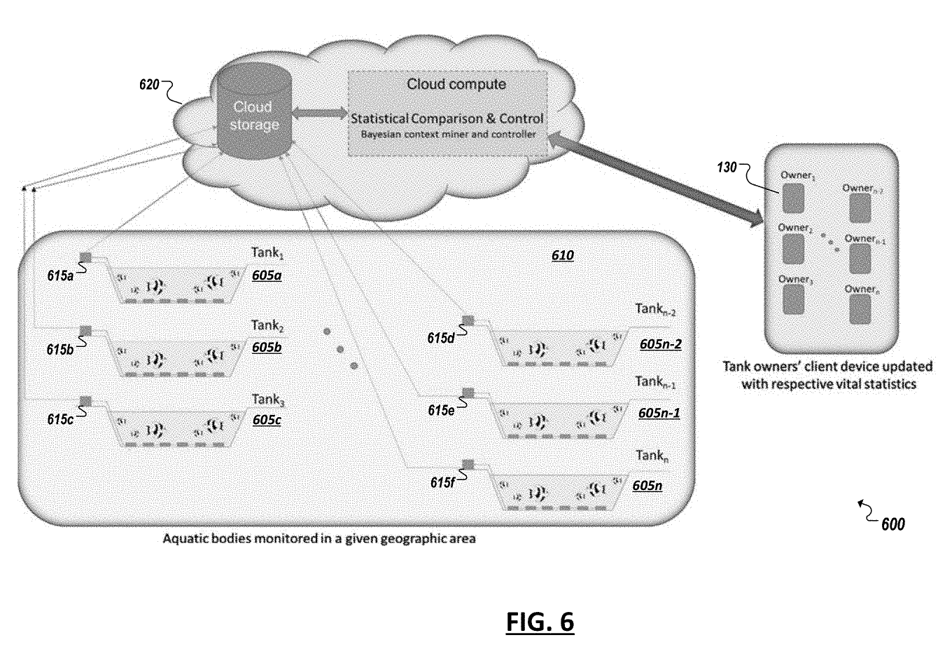

With reference to FIG. 6, an example system 600 (e.g., an IoT system) to manage one or more aquatic resources is illustrated. At least in the illustrated example, system 600 can manage multiple aquatic tanks (e.g., 605a-605n), within a defined area 610. Example tanks include, but are not limited to, home aquariums (e.g., tanks having less than two hundred gallons), commercial aquariums (e.g., tanks having greater than two hundred gallons), commercial tanks (e.g., fishery tanks, water storage tanks, etc.), swimming pools, and other closed systems, although other aquatic environments, including open systems (e.g., rivers, streams, lakes, ponds, etc.), semi-open systems (e.g., farm land, livestock aquifers, and other agricultural water system), and other aquatic environments may be similarly managed. Area 610 may be defined with regards to geography (e.g., town, city, state, region, country, etc.), the type of tank, the type of aquatic life in the tanks, and the users (e.g., individuals, public entities, private entities, etc.) of system 600, among other example common elements or characteristics that could be utilized to define area 610.

One or more sensors may be deployed in tanks (e.g., 605a-605n) or other aquatic environment, which can be the same type of senor capable of detecting the same aquatic condition(s) or different types or sensors, each capable of detecting a different aquatic condition. Tanks (e.g., 605a-605n) may include the same or a similar set of sensors and/or sensor configuration, or at least two of the tanks may include a different set of sensors and/or sensor configuration. The sensors in each tank can individually or collectively detect aquatic conditions related to, for example, movement, temperature, salinity, pH, specific chemicals, and/or specific chemical compounds, among several other examples and generate aquatic sensor data representing the detected aquatic condition(s).

As noted, a number of different sensors on one or more devices may be deployed within a single aquatic environment (e.g., a tank, pool, body of water, etc.). In some implementations, a corresponding sensor hub (e.g., 615a-f) (e.g., such as an IoT gateway including a microcontroller) may be in communication and associated with each sensor or set of sensors deployed in each respective tank 605 and is in further communication with a wired and/or wireless network (e.g., which can be a cloud network, the Internet, wide area network (WAN), local area network (LAN), wireless local area network (WLAN), metropolitan area network (MAN), or SAN (system area network, small area network, server area network), and/or the like networks). Each senor hub 615 can receive aquatic sensor data from its associated sensor(s) and transmit the aquatic sensor data to network.

In the illustrated example of FIG. 6, network 120 is a cloud network including at least a portion 620 of system 600 (e.g., including an application server, a management system, and an aquatic condition optimization system, among other examples or omissions of one or more of the application server, the management system, and/or aquatic condition optimization system). The portion 620 of system 600 can be capable of determining one or more aquatic conditions and quantities of the aquatic condition(s) for one or more of tanks 605 in accordance with an aquatic resource management application executable by the portion 620 of system 600.

A set of optimal aquatic conditions for one or more of tanks 605₁-tank 605ₙ can determined the aquatic condition optimization system (e.g., 215) and accessed by the management system (e.g., 205). The management system can determine a level of health for one or more of tanks 605₁-tank 605ₙ and generate one or more outputs representing the level of health for each or all of tanks 605₁-tank 605ₙ. The output(s), if needed or desired, may include service tickets, alerts, and/or other actions (e.g., corrective actions) based on the determined level of health for one or more of tanks 605₁-tank 605ₙ.

The output(s) can be presented in a report or graphical user interface (GUI) of one or more user devices (e.g., 130). User devices (e.g., 130) may be utilized in a variety of ways within system 600. User devices 130 may possess management system functionality, functionality of an IoT aquatic resource management development system, may be utilized to control or manage a particular IoT aquatic resource management application (e.g., through a GUI or user interface (UI) of the IoT aquatic resource management application provided on the device 130), or to provide other assets (e.g., sensor, actuator, computing, or storage) for use in a particular IoT aquatic resource management application deployment. In one example, a user device 130 may include a UI engine, which may be leveraged in a particular IoT aquatic resource management application deployment to provide one or more UIs for use by a user in connection with the deployment. A user device 130 may include one or more data processors, one or more memory elements, a communication module enabling communication with other systems using wireless and/or wireline network connections, and an operating system on which one or more applications may be run. A user device 130 may include one or more input devices, which may embody sensors implementing a touchscreen interface, keyboard, tracker ball, camera, or other mechanism through which user inputs may be captured. A user device 130 may also include one or more presentation devices (e.g., driven by corresponding actuators) to implement a graphical display, an audio presentation (e.g., speakers), a light output (e.g., of an integrated LED flashlight or camera flash), or vibration motor to output vibration-based signals, among other examples. Input devices and presentation devices, and computing resources of a user device (e.g., 130) may be utilized to fulfill UI requirements of a particular IoT aquatic resource management application, resulting in the deployment of a user device (e.g., 130) in connection with deployment of the particular IoT aquatic resource management application, among other example uses.

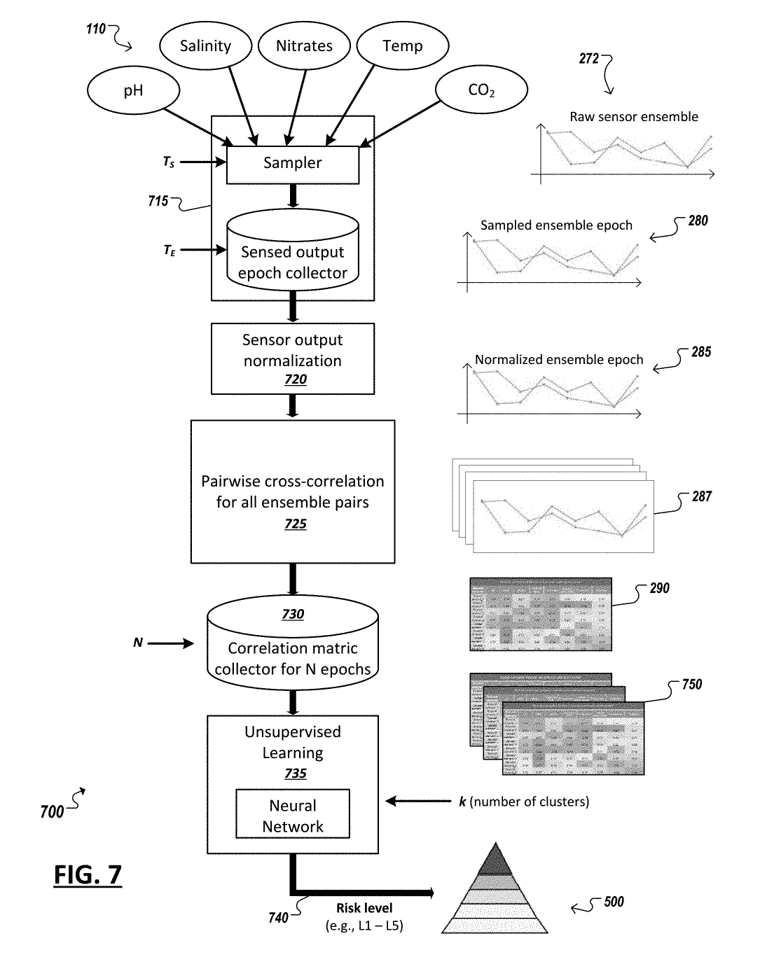

Referring now to FIG. 7, an example flow diagram 700 is illustrated of an aquatic resource management application executed by one or more host systems. One or more sensors (e.g., 110) may be deployed in one or more aquatic environments within a region, with the sensors in each aquatic environment capable of transmitting aquatic sensor data representing one or more aquatic conditions detected/sensed in a respective aquatic environment. In this example, the aquatic environment may include a number of tanks and various aquatic conditions may be sensed in the aquatic environment(s) by the deployed sensors, such as pH, salinity, nitrates, dissolved oxygen (O₂), temperature, dissolved carbon dioxide (CO₂), phosphates, and sulphates, among other examples.

Multiple raw aquatic sensor data ensembles (e.g., 272) may be generated from the varied aquatic sensor data (e.g., raw aquatic sensor data) received from one or more sensor devices in each tank. The raw aquatic sensor data may be parsed, as desired/needed, and data representing different aquatic conditions may be paired with one another to generate the multiple raw aquatic sensor data ensembles 272. In one example, raw pH data may be paired with raw temperature data to generate a raw pH/temperature data ensemble, which can be generated for each tank based on the aquatic sensor data from each respective tank. In a similar example, raw dissolved O₂ data may be paired with raw dissolved carbon dioxide CO₂ data from the aquatic sensor data obtained from each tank to generate a respective raw dissolved O₂/CO₂ data ensemble for each tank. Accordingly, a raw aquatic sensor data ensemble (e.g., 272) can be generated for each respective combination of pairs of different aquatic condition data values (i.e., paired combination of pH, salinity, nitrates, dissolved O₂, temperature, dissolved carbon dioxide CO₂, phosphates, and sulphates for a total of fifty-six pairs of different aquatic conditions in this example) for each respective tank can be generated (e.g., a total of fifty-six raw aquatic sensor data ensembles for each respective tank in a set of six tanks).

Each raw aquatic sensor data ensemble (e.g., 272) is sampled over a period of time defining an epoch of time (T_{E}) to generate multiple sampled ensemble epochs (e.g., 280) (block 715). For example, a respective sampled ensemble epoch 280 can be generated from each respective raw aquatic sensor data ensemble 272 that is generated for each respective tank or a total of fifty-six sampled ensemble epochs for each respective tank. Each sampled ensemble epoch 280 represents data samples of the paired aquatic sensor data in its corresponding raw aquatic sensor data ensemble 272 taken at one or more periodic sampling times (T_{S}), which can occur at, for example, eight sampling periods (e.g., T₀ through T₇) of one second (1s), which defines an epoch of time T_{E} of seven seconds for this example, although other sampling period lengths of time, number of sampling periods, and/or epoch lengths of time may be used.

Each sampled ensemble epoch 280 is normalized to generate multiple normalized ensemble epochs (e.g., 285) (i.e., fifty-six normalized ensemble epochs in this example) for each respective tank (at block 720). The sampled raw aquatic sensor data 285 in each sampled ensemble epoch 280 may be normalized relative to the maximum value in each aquatic sensor data stream, which harmonizes data streams from the various sensors (e.g., 110) since each sensor can have its own minimum and maximum frequency values for any given epoch of time T_{E}. Various implementations limit the normalized values of the sampled raw aquatic sensor data to a value between, for example, 0.0 and 1.0, among other example values and/or ranges of values.

A mutual cross-correlation value (r_{xy}) for each pair of different sensed aquatic conditions represented by the normalized samples of raw aquatic sensor data can be calculated to generate multiple cross-correlation ensemble epochs (e.g., 287) (at block 725). Each mutual cross-correlation value may be calculated using equation (2), in which a covariance c_{xy} of the aquatic condition parameters can be calculated using equation (1), and sₓ and s_{y} are defined in equation (3), each of which is discussed above with reference to FIG. 2. The mutual cross-correlation values can be limited to a value between, for example, −1.0 and 1.0, among other example values and/or ranges of values.

An epoch cross-correlation matrix (e.g., 290) can be populated with the calculated mutual cross-correlation values for each pair of normalized sampled raw aquatic sensor data in each cross-correlation ensemble epoch (at block 730). Blocks 705-730 may be similarly performed for each tank or aquatic environment in a particular collection (e.g., corresponding to a particular geographic location, water management district, classification of aquatic environment (e.g., pools or spas manufactured by the same contractor), etc.).

In one example, ensembles may be generated for each of a number (e.g., six) of tanks. Accordingly, in this example, a collection (e.g., 750) of six epoch cross-correlation matrices (i.e., an epoch cross-correlation matrix 290 corresponding to each of the six tanks) are populated with the calculated mutual cross-correlation values for each pair of normalized sampled raw aquatic sensor data. This example calculates sixty-four mutual cross-correlation values (i.e., a mutual cross-correlation value r_{xy} for each of the fifty-six pairs of different aquatic conditions and a value (e.g., 1.00) for each of the eight pairs correlating same aquatic condition), among other examples that may calculate a greater number or a fewer number of mutual cross-correlation values. Each epoch cross-correlation matrix 290 can be considered asynchronously generated because the aquatic sensor data from which each epoch cross-correlation matrix 290 is based, can be detected/sensed at different times and/or are detected/sensed at a different tank.

The optimal condition (e.g., quantity or level) of one or more of the selected the aquatic conditions (i.e., pH, salinity, nitrates, dissolved O₂, temperature, dissolved carbon CO₂, phosphates, and sulphates in this example) of the tanks can be determined (at block 735). The optimal condition(s) may be determined using a neural network-based unsupervised learning machine that is fed the epoch cross-correlation matrices populated with the calculated mutual cross-correlation values for each pair of normalized sampled raw aquatic sensor data in each normalized ensemble epoch. In certain implementations, one or more advanced mathematical algorithms (e.g., Bayesian networks created by structure search using a Bayesian model score or approximation, linear classifiers, such as support vector machines (SVMs), and/or the like algorithms) that facilitate unsupervised learning is utilized to determine the overall health or condition of the tank(s). In one example, the optimal condition for each aquatic condition is the result of a “winner-take-all” determination for each tank or subset of tanks. In another example, the optimal condition for each aquatic condition is the result of a singled out k-means cluster that designates a cluster (e.g., via cluster analysis) corresponding to each possible output for a particular tank, two or more tanks, or all of tanks, etc.

One or more levels of health for one or more of tanks may be communicated to one or more users (e.g., via user device(s)) (at block 740). One or more service tickets, warnings, and/or sets of corrective actions may be included in the communication to the user(s). One example includes five levels of aquatic health similar to the example discussed above with reference to FIG. 5.

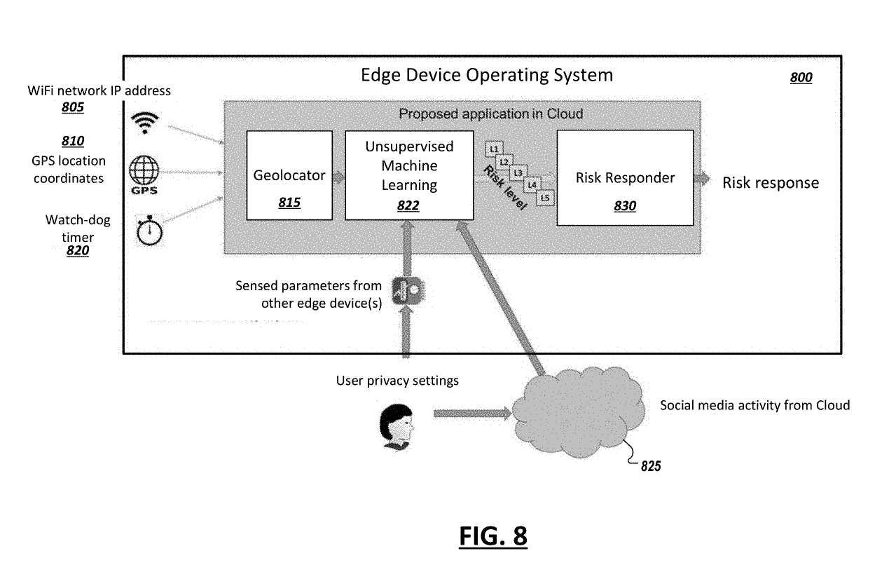

Referring to FIG. 8, a block diagram is shown illustrating a simplified representation of a device 800 (e.g., an “edge” device) to manage one or more aquatic resources. The device, which may be similar to other devices discussed herein, can include one or more sensors and/or actuators and is capable of being used in a variety of aquatic environments and detect a variety of aquatic environmental conditions.

In one example, device 800 operates within an IoT or WSN system (e.g., a system where multiple devices are working and communicating in concert to detect current aquatic conditions and determine one or more optimal conditions) and may include functionality for using an aquatic resource management model generated by an aquatic resource management application to detect, in real time, aquatic conditions sensed or experienced by device 800. The aquatic condition data can describe, for example, water movement (e.g., tidal, flow rate, etc.), temperature, salinity, pH, specific chemicals, or specific chemical compounds, among several other examples.

An IP address (e.g., 805) is provided to device 800 so that device 800 can be accessed via one or more networks (e.g., a cloud network and/or network 120). The example of FIG. 8 includes a WiFi network IP address so that device 800 can communicate via WiFi. Device 800 may also include GPS capabilities 810 and/or have access to GPS data (e.g., location coordinates). GPS data can be fed to a geo-locator module (e.g., 815) that may at least partially be located in the cloud network so that the current geographic location of device 800 can be determined (e.g., by using GPS coordinates).

A watchdog timer (e.g., 820) enables device 800 to conserve power by activating itself as needed and/or desired. In some implementations, watchdog timer 820 provides “Adaptive turn-on” capabilities to facilitate active power consumption when a shift in activity is detected (e.g., device 800 detects activity) or otherwise be in a power saving mode (e.g., a sleep mode) when activity is not detected.

Device 800 can also access (e.g., via a cloud network) various implementations of hardware and/or applications (e.g., an application server (e.g. 145), a management system (e.g., 205), and/or an aquatic condition optimization system (e.g., 215)) that determine(s) one or more optimal conditions for one or more aquatic resources. In one example, the hardware and/or application(s) can generate one or more epoch cross-correlation matrices (e.g., 290) based on a calculated mutual cross-correlation value (r_{xy}) for multiple pairs of different aquatic conditions, which calculations are calculated from multiple normalized ensemble epochs (e.g., 285), which are derived from multiple sampled ensemble epochs (e.g., 280), which are derived from multiple raw aquatic sensor data ensembles (e.g., 272), which are derived from raw aquatic sensor data (e.g., 275) generated by device 800.

The implementations of hardware and/or software at least partially residing in the cloud network can communicate with network 120 to receive subjective and/or objective data about one or more aquatic resources associated with device 800 from one or more third-parties (e.g., 825). Examples of third-party source(s) of subjective/objective data about one or more aquatic resources associated with device 800 include, but are not limited to, social media resources (e.g., user posts describing various local events), sources of climate/weather information, sources of news, government resources, and/or the like sources of subjective/objective data. Such social media feeds and other data from third-party data sources may be utilized as textual inputs to track any local events that can potentially have an effect on the aquatic source (e.g., upcoming flood or bad weather warnings, local event announcements in the area that can have an effect on contamination of the water, etc.). Such additional information may be used to aid in better gauging the risk of the water quality and may be mapped to results generated by one or more unsupervised machine learning algorithms to provide context for the results, among other examples.

The hardware and/or software implementations (e.g., an aquatic condition optimization system (e.g., 215)) can apply unsupervised machine learning algorithms 822 (e.g., a Bayesian context mining algorithm, a support vector machine, etc.) to a combination of the third-party subjective/objective data and the mutual cross-correlation data in one or more epoch cross-correlation matrices (e.g., 290) to generate an output that can be used (e.g., by aquatic resource management logic (e.g., 220)) to facilitate a determination and/or a prediction of one or more levels of health and/or risks. An output from the combined third-party and cross-correlation data can be the result of a “winner-take-all” determination or the result of a singled out k-means cluster that designates a cluster (e.g., via cluster analysis) corresponding to a set of outputs.

The one or more levels of health and/or risk can be communicated to a risk response manager (e.g., 830) that can control one or more processes to initiate one or more risk mitigation actions in response to received health/risk level(s). A risk response manager 830 can communicate the mitigation action(s), which can include, for example, a high-alert broadcast to all subscribers in an area, a high-alert notification to a specific subscriber, a red flag indicator, periodic subscriber notifications, and/or the like responses, among other examples.

Device 800 may include one or more security features (e.g., privacy settings) to protect device 800 from security threats. The security features can be set features and/or features that an be set and/or updated by a user. The security feature(s) can be applied to one or more sensors and/or more or more sources of third-party information.

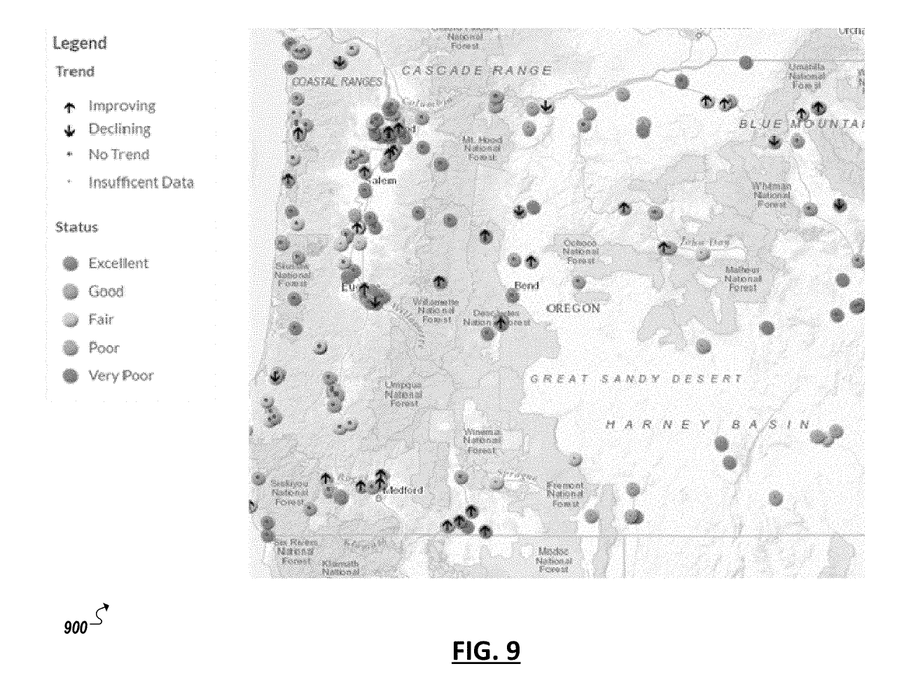

FIG. 9 illustrates an example map 900 that illustrates a geographic region including multiple aquatic resources (e.g., lakes, ponds, streams, etc.) that identifies a state of health for each respective aquatic resource. The state of health of each aquatic resource or a subset of aquatic resources can be determined in accordance with the various examples and implementations set for above. The map 900 may be incorporated as a portion of a dashboard or other technique for displaying information. The state of health for each of the various aquatic resources can be represented in any manner that can be interpreted by a human and/or device. In some examples, the state of health is visually represented using, for example, colors, symbols, numbers, and/or letters, among other visual examples or cues. The map 900 may form a portion of a GUI or other type of UI included on a user device (e.g., 130) to present risk response outcomes determined by an example aquatic resource management system, among other examples.

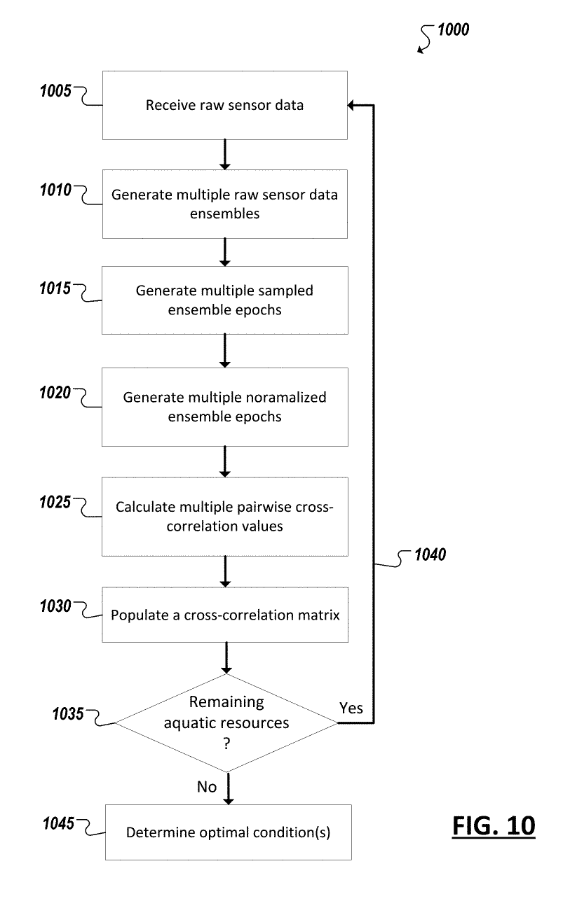

FIG. 10 is a flowchart illustrating an example method 1000 to determine one or more optimal conditions for one or more aquatic resources. Raw senor data representing one or more aquatic conditions detected/sensed in an aquatic resource is received from one or more sensors (block 1005). The aquatic conditions may be any aquatic condition, chemical, and/or chemical compound that could affect the health of an aquatic resource.

Multiple raw aquatic sensor data ensembles may be generated from the aquatic sensor data (e.g., raw aquatic sensor data) from the aquatic resource (block 1010). The raw aquatic sensor data may be parsed, as desired/needed, and data representing different aquatic conditions are paired with one another to generate the multiple raw aquatic sensor data ensembles. Accordingly, a raw aquatic sensor data ensemble can be generated for each respective combination of pairs of different aquatic conditions.

Each raw aquatic sensor data ensemble is sampled over a period of time defining an epoch of time (T_{E}) to generate multiple sampled ensemble epochs (block 1015). Each sampled ensemble epoch represents data samples of the paired aquatic sensor data in its corresponding raw aquatic sensor data ensemble taken at one or more periodic sampling times (T_{S}), which can occur at, for example, eight sampling periods (e.g., T₀ through T₇) of one second (1 s), which defines an epoch of time T_{E} of seven seconds for this example, although other sampling period lengths of time, number of sampling periods, and/or epoch lengths of time may be used.

Each sampled ensemble epoch is normalized to generate multiple normalized ensemble epochs (block 1020). The sampled raw aquatic sensor data in each sampled ensemble epoch may be normalized relative to the maximum value in each aquatic sensor data stream, which harmonizes data streams from the various sensors since each sensor can have its own minimum and maximum frequency values for any given epoch of time T_{E}. Various implementations limit the normalized values of the sampled raw aquatic sensor data to a value between, for example, 0.0 and 1.0, among other example values and/or ranges of values.

A mutual cross-correlation value (r_{xy}) for each pair of different sensed aquatic conditions represented by the normalized samples of raw aquatic sensor data can be calculated (block 1025). The mutual cross-correlation value may be calculated using equation (2), in which a covariance c_{xy} of the aquatic condition parameters can be calculated using equation (1), and sₓ and s_{y} are defined in equation (3), each of which is discussed above with reference to FIG. 2. The mutual cross-correlation values can be limited to a value between, for example, −1.0 and 1.0, among other example values and/or ranges of values.

An epoch cross-correlation matrix can be populated with the calculated mutual cross-correlation values for each pair of normalized sampled raw aquatic sensor data (block 1030). Each epoch cross-correlation matrix can be considered asynchronously generated because the aquatic sensor data from which each epoch cross-correlation matrix 290 is generated, can be detected/sensed at different times.

A query is made to determine if there are any remaining epoch cross-correlation matrices 290 that can be populated for a different aquatic resource (block 1035). If a matrix can be populated for one or more remaining aquatic resources (i.e., YES), blocks 1005 through 1035 can be repeated (return 1040) until there are no remaining epoch cross-correlation matrices.

When there are no remaining epoch cross-correlation matrices (i.e., NO), an optimal condition (e.g., quantity or level) for one or more of the aquatic conditions can be determined (block 1045). The optimal condition(s) can be determined using a neural network-based unsupervised learning machine that is fed the epoch cross-correlation matrices populated with the calculated mutual cross-correlation values. In certain implementations, one or more advanced mathematical algorithms (e.g., Bayesian networks created by structure search using a Bayesian model score or approximation, linear classifiers, such as support vector machines (SVMs), and/or the like algorithms) that facilitate unsupervised learning is utilized to determine the optimal condition(s).

In one example, each optimal condition is the result of a “winner-take-all” determination. In another example, an output is the result of a singled out k-means cluster that designates a cluster (e.g., via cluster analysis) corresponding to each aquatic condition.

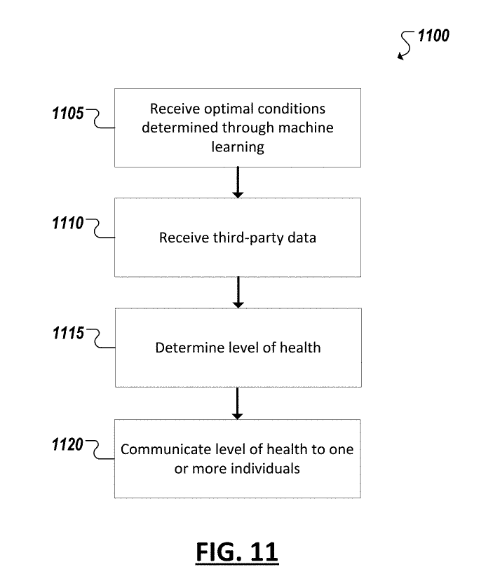

FIG. 11 is a flowchart illustrating an example method 1100 to determine one or more level of health for one or more aquatic resources. An output including a representation of an optimal condition for one or more aquatic conditions related to one or more aquatic resources can be received (block 1105). The optimal condition(s) can be based on the application of unsupervised machine learning algorithms (e.g., Bayesian algorithms) to mutual cross-correlation values r_{xy} calculated for each of the pairs of different aquatic conditions, as set forth in various examples discussed above.

Subjective and/or objective data related to the one or more aquatic resources may be received from one or more third-party resources (block 1110). Examples of third-party sources of subjective/objective data include, but are not limited to, social media resources, sources of climate/weather information, sources of news, government resources, and/or the like sources of subjective/objective data.

The level of health for one or more of the aquatic resources may be determined and/or predicted (block 1115). In one example, the determination can be based on a comparison of the current condition(s) to the optimal condition(s). In another example, the determination can be based on a combination of a comparison of the current condition(s) to the optimal condition(s) and an analysis of the subjective and/or objective data.

One or more outputs representing to determination and/or prediction can be communicated to one or more individuals or entities (block 1120). The output may be communicated to one or more user of subscribers (e.g., via user device(s)). Alternatively or additionally, the output may be a widespread broadcast to a population of interest. In one example, one or more outputs include one or more service tickets, alerts, and/or other actions (e.g., corrective actions) based on the level of health.

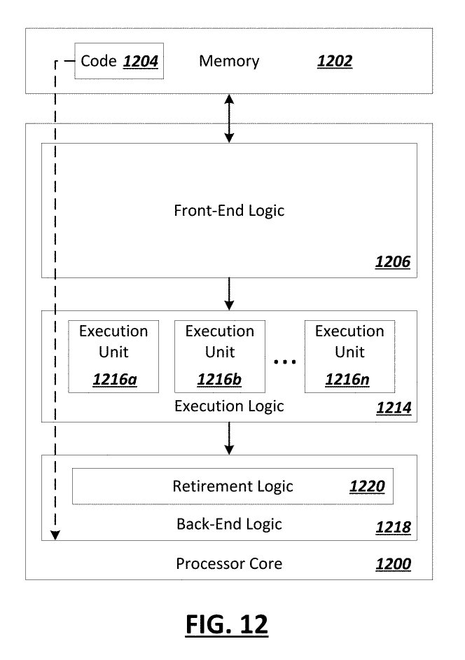

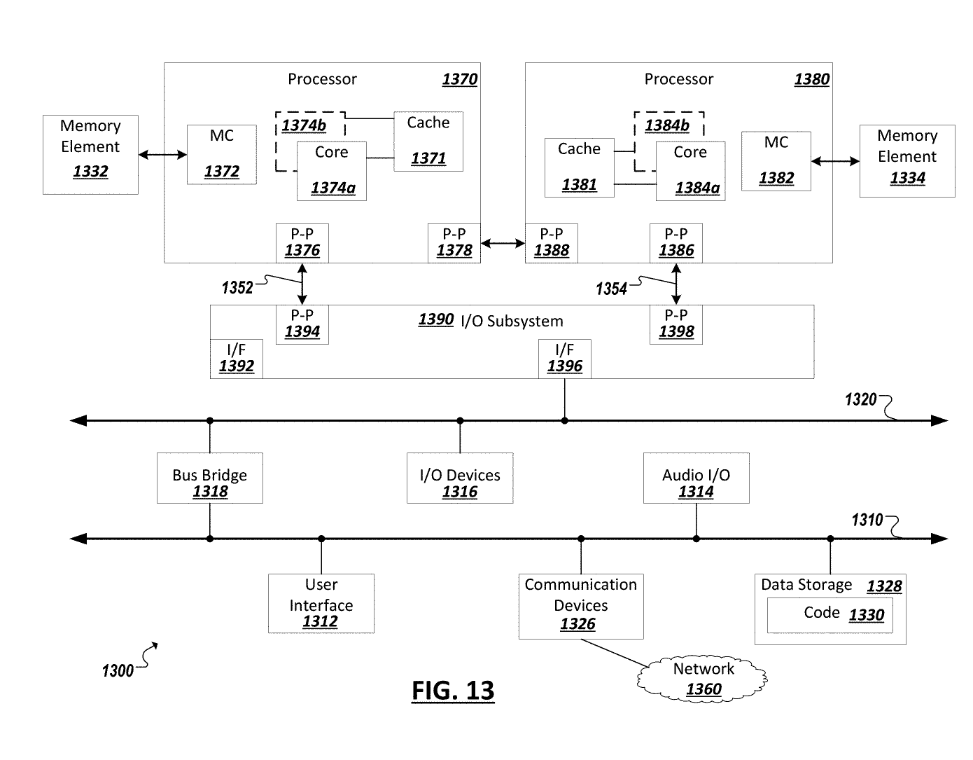

FIGS. 12-13 are block diagrams of exemplary computer architectures that may be used in accordance with embodiments disclosed herein. Other computer architecture designs known in the art for processors and computing systems may also be used. Generally, suitable computer architectures for embodiments disclosed herein can include, but are not limited to, configurations illustrated in FIGS. 12-13.

FIG. 12 is an example illustration of a processor according to an embodiment. Processor 1200 is an example of a type of hardware device that can be used in connection with the implementations above. Processor 1200 may be any type of processor, such as a microprocessor, an embedded processor, a digital signal processor (DSP), a network processor, a multi-core processor, a single core processor, or other device to execute code. Although only one processor 1200 is illustrated in FIG. 12, a processing element may alternatively include more than one of processor 1200 illustrated in FIG. 12. Processor 1200 may be a single-threaded core or, for at least one embodiment, the processor 1200 may be multi-threaded in that it may include more than one hardware thread context (or “logical processor”) per core.

FIG. 12 also illustrates a memory 1202 coupled to processor 1200 in accordance with an embodiment. Memory 1202 may be any of a wide variety of memories (including various layers of memory hierarchy) as are known or otherwise available to those of skill in the art. Such memory elements can include, but are not limited to, random access memory (RAM), read only memory (ROM), logic blocks of a field programmable gate array (FPGA), erasable programmable read only memory (EPROM), and electrically erasable programmable ROM (EEPROM).

Processor 1200 can execute any type of instructions associated with algorithms, processes, or operations detailed herein. Generally, processor 1200 can transform an element or an article (e.g., data) from one state or thing to another state or thing.

Code 1204, which may be one or more instructions to be executed by processor 1200, may be stored in memory 1202, or may be stored in software, hardware, firmware, or any suitable combination thereof, or in any other internal or external component, device, element, or object where appropriate and based on particular needs. In one example, processor 700 can follow a program sequence of instructions indicated by code 1204. Each instruction enters a front-end logic 706 and is processed by one or more decoders 1208. The decoder may generate, as its output, a micro operation such as a fixed width micro operation in a predefined format, or may generate other instructions, microinstructions, or control signals that reflect the original code instruction. Front-end logic 706 also includes register renaming logic 710 and scheduling logic 1212, which generally allocate resources and queue the operation corresponding to the instruction for execution.

Processor 1200 can also include execution logic 1214 having a set of execution units 1216a, 1216b, 1216n, etc. Some embodiments may include a number of execution units dedicated to specific functions or sets of functions. Other embodiments may include only one execution unit or one execution unit that can perform a particular function. Execution logic 1214 performs the operations specified by code instructions.

After completion of execution of the operations specified by the code instructions, back-end logic 1218 can retire the instructions of code 1204. In one embodiment, processor 1200 allows out of order execution but requires in order retirement of instructions. Retirement logic 1220 may take a variety of known forms (e.g., re-order buffers or the like). In this manner, processor 1200 is transformed during execution of code 1204, at least in terms of the output generated by the decoder, hardware registers and tables utilized by register renaming logic 1210, and any registers (not shown) modified by execution logic 1214.

Although not shown in FIG. 12, a processing element may include other elements on a chip with processor 1200. For example, a processing element may include memory control logic along with processor 1200. The processing element may include I/O control logic and/or may include I/O control logic integrated with memory control logic. The processing element may also include one or more caches. In some embodiments, non-volatile memory (such as flash memory or fuses) may also be included on the chip with processor 700.

FIG. 13 illustrates a computing system 1300 that is arranged in a point-to-point (PtP) configuration according to an embodiment. In particular, FIG. 13 shows a system where processors, memory, and input/output devices are interconnected by a number of point-to-point interfaces. Generally, one or more of the computing systems described herein may be configured in the same or similar manner as computing system 1200.

Processors 1370 and 1380 may also each include integrated memory controller logic (MC) 1372 and 1382 to communicate with memory elements 1332 and 1334. In alternative embodiments, memory controller logic 1372 and 1382 may be discrete logic separate from processors 1370 and 1380. Memory elements 832 and/or 834 may store various data to be used by processors 1370 and 1380 in achieving operations and functionality outlined herein.

Processors 1370 and 1380 may be any type of processor, such as those discussed in connection with other figures. Processors 1370 and 1380 may exchange data via a point-to-point (PtP) interface 1350 using point-to-point interface circuits 1378 and 1388, respectively. Processors 1370 and 1380 may each exchange data with a chipset 1390 via individual point-to-point interfaces 1352 and 1354 using point-to-point interface circuits 1376, 1386, 1394, and 1398. Chipset 1390 may also exchange data with a high-performance graphics circuit 1338 via a high-performance graphics interface 839, using an interface circuit 1392, which could be a PtP interface circuit. In alternative embodiments, any or all of the PtP links illustrated in FIG. 13 could be implemented as a multi-drop bus rather than a PtP link.

Chipset 1390 may be in communication with a bus 1320 via an interface circuit 1396. Bus 1320 may have one or more devices that communicate over it, such as a bus bridge 1318 and I/O devices 1316. Via a bus 1310, bus bridge 1318 may be in communication with other devices such as a user interface 1312 (such as a keyboard, mouse, touchscreen, or other input devices), communication devices 1326 (such as modems, network interface devices, or other types of communication devices that may communicate through a computer network 1360), audio I/O devices 1314, and/or a data storage device 1328. Data storage device 1328 may store code 1330, which may be executed by processors 1370 and/or 1380. In alternative embodiments, any portions of the bus architectures could be implemented with one or more PtP links.

The computer system depicted in FIG. 13 is a schematic illustration of an embodiment of a computing system that may be utilized to implement various embodiments discussed herein. It will be appreciated that various components of the system depicted in FIG. 8 may be combined in a system-on-a-chip (SoC) architecture or in any other suitable configuration capable of achieving the functionality and features of examples and implementations provided herein.

Various implementations of one or more of the examples discussed above can be used to predict or forecast aquatic conditions similar to forecasting weather. Forecasting aquatic conditions may be accomplished widespread deployment of water quality IoT monitoring systems (e.g., system(s) 100, 101, 200, and/or 600) can enable predictive forecasting for lakes, ponds, rivers, and streams.

One example can include monitoring and mitigating pollution plumes resulting from chemical spills in the environment. Another example may include monitoring contamination injected by overflow of sewage treatment plants, which often don't have the peak capacity to process wastewater following periods of heavy rain.

Collection of aggregate data and analysis using one or more of the various implementations (e.g., system(s) 100, 101, 200, and/or 600) has the advantage that time evolution of water quality measurements may be used to trace back the actual pollution source. Applications may include: 1) pinpoint where contaminant source originated; 2) estimate total quantify a chemical spill; 3) monitor time evolution of pollution plume; and 4) predict time evolution of chemical concentration (e.g., when conditions at each sensor point will go back to the normal L5 level).

Other applications may use recursive state estimation techniques (e.g., a Kalman filter or Particle filter) to predict the spatial evolution of water quality overtime. Long term analysis can be used to influence, for example, fish hatcheries in quantifying the quantity of fish, type, and breed needed to meet survival targets in the wild.

A Kalman Filter is a method of recursive state estimation that can find wide application in signal processing. Given a history of measurements, a Kalman filter can be used to build a model for the state of a system that maximizes the a posteriori (i.e., in hindsight) probability of prior measurements. In addition, the entire history of measurements can be condensed such that the state at time k can be modeled in terms of only the prior state at time k-1. The key assumption for the Kalman Filter is that the system is linear and subject to white Gaussian noise. Nonlinear systems may be handled with implementation of a Particle Filter. In this application, given the current state of the distribution of a particular water condition (e.g., temperature, chemical concentration, etc.), a Kalman filter and/or Particle Filter may be implemented to predict/track the distribution in the next future time step.

Another application may provide deployment of water quality IoT monitoring systems (e.g., system(s) 100, 101, 200, and/or 600) underwater. Such systems can suffer from high signal attenuation in water across most of the electromagnetic spectrum. However, portions of the blue-green visible spectrum are transparent, as are sonar acoustical waves. One example water quality IoT monitoring system may include hardware and/or applications in which aquatic sensor data (e.g., 275) is transmitted underwater using blue-green laser diodes and/or sonar, up to a floating base station on the water surface (i.e., edge processing), which then transmits the aquatic sensor data as radio frequency (RF) signals (e.g., 5G wireless) to link up to one or more networks (e.g., 120).

While some of the systems and solutions described and illustrated herein have been described as containing or being associated with a plurality of elements, not all elements explicitly illustrated or described may be utilized in each alternative implementation of the present disclosure. Additionally, one or more of the elements described herein may be located external to a system, while in other instances, certain elements may be included within or as a portion of one or more of the other described elements, as well as other elements not described in the illustrated implementation. Further, certain elements may be combined with other components, as well as used for alternative or additional purposes in addition to those purposes described herein.

Further, it should be appreciated that the examples presented above are non-limiting examples provided merely for purposes of illustrating certain principles and features and not necessarily limiting or constraining the potential embodiments of the concepts described herein. For instance, a variety of different embodiments can be realized utilizing various combinations of the features and components described herein, including combinations realized through the various implementations of components described herein. Other implementations, features, and details should be appreciated from the contents of this Specification.

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures do not necessarily require the particular order shown, or sequential order, to achieve the desired results. In certain implementations, multitasking and parallel processing may be advantageous. Additionally, other user interface layouts and functionality can be supported. Other variations are within the scope of the following claims.

In general, one aspect of the subject matter described in this specification can be embodied in methods and executed instructions that include or cause the actions of identifying a sample that includes software code, generating a control flow graph for each of a plurality of functions included in the sample, and identifying, in each of the functions, features corresponding to instances of a set of control flow fragment types. The identified features can be used to generate a feature set for the sample from the identified features

These and other embodiments can each optionally include one or more of the following features. The features identified for each of the functions can be combined to generate a consolidated string for the sample and the feature set can be generated from the consolidated string. A string can be generated for each of the functions, each string describing the respective features identified for the function. Combining the features can include identifying a call in a particular one of the plurality of functions to another one of the plurality of functions and replacing a portion of the string of the particular function referencing the other function with contents of the string of the other function. Identifying the features can include abstracting each of the strings of the functions such that only features of the set of control flow fragment types are described in the strings. The set of control flow fragment types can include memory accesses by the function and function calls by the function. Identifying the features can include identifying instances of memory accesses by each of the functions and identifying instances of function calls by each of the functions. The feature set can identify each of the features identified for each of the functions. The feature set can be an n-graph.

Further, these and other embodiments can each optionally include one or more of the following features. The feature set can be provided for use in classifying the sample. For instance, classifying the sample can include clustering the sample with other samples based on corresponding features of the samples. Classifying the sample can further include determining a set of features relevant to a cluster of samples. Classifying the sample can also include determining whether to classify the sample as malware and/or determining whether the sample is likely one of one or more families of malware. Identifying the features can include abstracting each of the control flow graphs such that only features of the set of control flow fragment types are described in the control flow graphs. A plurality of samples can be received, including the sample. In some cases, the plurality of samples can be received from a plurality of sources. The feature set can identify a subset of features identified in the control flow graphs of the functions of the sample. The subset of features can correspond to memory accesses and function calls in the sample code.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The following examples pertain to embodiments in accordance with this Specification. One or more embodiments may provide a method, a system, apparatus, and a machine readable storage medium with stored instructions executable to identify a collection of aquatic data, wherein the collection of data comprises data generated by and collected from one or more aquatic sensors, generate a set of cross-correlation matrices based on the collection of aquatic data, execute a set of unsupervised machine learning algorithms using the set of cross-correlation matrices, and determine one or more optimum conditions for one or more aquatic resources based on the executed set of unsupervised machine learning algorithms.

In one example, one or more corrective actions are determined based on the determined one or more optimum conditions.

In one example, information that identifies the determined optimum conditions for the one or more aquatic resources and/or information that identifies the one or more corrective actions is communicated to a user.

In one example, the collection of aquatic data is collected from a plurality of aquatic sensors and at least two aquatic sensors are different types of aquatic sensors.

In one example, the collection of aquatic data is collected from a plurality of different aquatic resources.

In one example, the collection of aquatic data is collected from one of a plurality of open aquatic resources and a plurality of closed aquatic resources.

In one example, the aquatic data comprises asynchronous samples from a plurality of aquatic resources.

In one example, a single cross-correlation matrix is generated when the set of cross-correlation matrices is generated.

In one example, a plurality of cross-correlation matrices is generated when the set of cross-correlation matrices is generated. In some aspects, each cross-correlation matrix is populated with a plurality of calculated pairwise cross-correlation values based a plurality of data ensembles. In various aspects, each pairwise cross-correlation value is based on data samples representing a pair of different aquatic condition parameters. In some aspects, each pair of different aquatic condition parameters (x, y) includes a cross-correlation value r_{xy} that is calculated in accordance with equation (2), wherein, a covariance c_{xy}(k) of each pair of cross-correlated pair of different parameters is calculated in accordance with equation (1) and sₓ and s_{y} are defined as: sₓ=\sqrt{cₓₓ(0)} and s_{y}=\sqrt{c_{yy}(0)}.

In one example, the set of unsupervised machine learning algorithms comprises a Bayesian unsupervised machine learning algorithm.

In one example, the set of unsupervised machine learning algorithms comprises one or more neural models.

One or more embodiments may provide a method including identifying a collection of aquatic data, wherein the collection of aquatic data comprises data generated by and collected from one or more aquatic sensors, generating a set of cross-correlation matrices based on the collection of aquatic data, executing a set of unsupervised machine learning algorithms using the set of cross-correlation matrices, and determining one or more optimum conditions for an aquatic system based on the executed set of unsupervised machine learning algorithms.

In one example, the method further includes determining one or more corrective actions based on the determined one or more optimum conditions and/or communicating information that identifies the determined optimum conditions for the aquatic system to the user and/or communicating information that identifies the one or more corrective actions to the user.

In one example, generating the set of cross-correlation matrices comprises generating a plurality of cross-correlation matrices and populating each cross-correlation matrix with a plurality of calculated pairwise cross-correlation values based a plurality of data ensembles, wherein each pairwise cross-correlation value is based on data samples representing a pair of different aquatic condition parameters.

One or more embodiments may provide a system including a data processor device, computer memory, and an aquatic conditions optimization management system, executable by the data processor device. The aquatic conditions optimization management system can identify a collection of aquatic data, wherein the collection of data comprises data generated by and collected from one or more aquatic sensors, generate a set of cross-correlation matrices based on the collection of aquatic data, execute a set of unsupervised machine learning algorithms using the set of cross-correlation matrices, and determine one or more optimum conditions for one or more aquatic resources based on the executed set of unsupervised machine learning algorithms.

In one example, the system further comprises the one or more aquatic sensors.

In one example, the set of unsupervised machine learning algorithms comprises a neural network to execute a Bayesian unsupervised machine learning algorithm.

In one example, one or more corrective actions are determined based on the determined one or more optimum conditions.

In one example, information that identifies the determined optimum conditions for the one or more aquatic resources and/or information that identifies the one or more corrective actions is communicated to a user.

In one example, the collection of aquatic data is collected from a plurality of aquatic sensors and at least two aquatic sensors are different types of aquatic sensors.

In one example, the collection of aquatic data is collected from a plurality of different aquatic resources.

In one example, the collection of aquatic data is collected from one of a plurality of open aquatic resources and a plurality of closed aquatic resources.

In one example, the aquatic data comprises asynchronous samples from a plurality of aquatic resources.

In one example, a single cross-correlation matrix is generated when the set of cross-correlation matrices is generated.

In one example, a plurality of cross-correlation matrices is generated when the set of cross-correlation matrices is generated. In some aspects, each cross-correlation matrix is populated with a plurality of calculated pairwise cross-correlation values based a plurality of data ensembles. In various aspects, each pairwise cross-correlation value is based on data samples representing a pair of different aquatic condition parameters. In some aspects, each pair of different aquatic condition parameters (x, y) includes a cross-correlation value r_{xy} that is calculated in accordance with equation (2), wherein, a covariance c_{xy}(k) of each pair of cross-correlated pair of different parameters is calculated in accordance with equation (1) and sₓ and s_{y} are defined as: sₓ=\sqrt{cₓₓ(0)} and s_{y}=\sqrt{c_{yy}(0)}.

In one example, the set of unsupervised machine learning algorithms includes a Bayesian unsupervised machine learning algorithm.

In one example, the set of unsupervised machine learning algorithms includes one or more neural models.

In one example, the set of unsupervised machine learning algorithms includes a recursive state estimation.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. At least one machine accessible storage medium having instructions stored thereon, the instructions when executed on a machine, cause the machine to:
identify a collection of aquatic data, wherein the collection of data comprises data generated by a plurality of different aquatic sensors and describes a plurality of conditions within a particular aquatic environment;
generate a set of cross-correlation matrices from the collection of aquatic data;
provide the set of cross-correlation matrices as an input to one or more unsupervised machine learning algorithms; and
determine one or more optimum conditions for the particular aquatic environment based on a result of the one or more unsupervised machine learning algorithms.

2. The storage medium of claim 1, wherein the instructions, when executed, further cause a machine to determine one or more recommendations for corrective action to address the one or more optimum conditions.

3. The storage medium of claim 2, wherein the instructions, when executed, further cause a machine to communicate to a user at least one of:
information that identifies the determined optimum conditions for the particular aquatic environment; and
information that identifies the one or more recommendations for corrective action.

4. The storage medium of claim 1, wherein the collection of aquatic data is collected from aquatic sensors in a plurality of different aquatic environments including the particular aquatic environment.

5. The storage medium of claim 1, wherein the aquatic data comprises asynchronous samples from the plurality of aquatic environments.

6. The storage medium of claim 1, wherein the particular aquatic environment comprises one of a water tank, a fish tank, a swimming pool, or portion of an open water environment.

7. The storage medium of claim 1, wherein the one or more unsupervised machine learning algorithms comprises a Bayesian unsupervised machine learning algorithm.

8. The storage medium of claim 7, wherein the Bayesian unsupervised machine learning algorithm comprises a Bayesian context mining algorithm.

9. The storage medium of claim 1, wherein generating a set of cross-correlation matrices from the collection of aquatic data comprises calculating pairwise cross-correlations between combinations of the plurality of conditions at each of a series of time epochs.

10. The storage medium of claim 9, wherein the set of cross-correlation matrices comprises a plurality of cross-correlation matrices, and the plurality of cross-correlation matrices comprises a respective cross-correlation matrix for each of the series of time epochs.

11. The storage medium of claim 10, wherein each pairwise cross-correlation value is based on data samples of the combinations of conditions representing a respective pair of different conditions in the plurality of conditions.

12. The storage medium of claim 11, wherein each pair of different conditions (x, y) includes a cross-correlation value r_{xy} that is calculated in accordance with a first calculation:
$${r}_{xy} = \frac{{c}_{xy} ( k )}{{s}_{x} {s}_{y}} k = 0 , \pm 1 , \pm 2 , … ,$$
wherein, a covariance c_{xy}(k) of each pair of cross-correlated pair of different parameters is calculated in accordance with a second calculation:
$${c}_{xy} ( k ) = \{ \begin{matrix}\frac{1}{n} {\sum }_{t = 1}^{n - k} ( {x}_{t} - \overline{x} ) ( {y}_{t + k} - \overline{y} ) ; k = 0 , 1 , 2 , … \\ \frac{1}{n} {\sum }_{t = 1}^{n + k} ( {y}_{t} - \overline{y} ) ( {x}_{t - k} - \overline{x} ) ; k = 0 , - 1 , - 2 , …\end{matrix} ;$$
and s, and s_{y} are defined according to:
sₓ=\sqrt{cₓₓ(0)}; and
s_{y}=\sqrt{c_{yy}(0)}.

13. A method, comprising:
identifying a collection of aquatic data, wherein the collection of data comprises data generated by a plurality of different aquatic sensors and describes a plurality of conditions within a particular aquatic environment;
generating a set of cross-correlation matrices from the collection of aquatic data;
providing the set of cross-correlation matrices as an input to one or more unsupervised machine learning algorithms; and
determining one or more optimum conditions for the particular aquatic environment based on a result of the one or more unsupervised machine learning algorithms.

14. The method of claim 13, further comprising calculating pairwise cross-correlations between combinations of the plurality of conditions at each of a series of time epochs, wherein the set of cross-correlation matrices are generated based on the pairwise cross-correlations.

15. The method of claim 14, wherein the set of cross-correlation matrices comprises a plurality of cross-correlation matrices, and the plurality of cross-correlation matrices comprises a respective cross-correlation matrix for each of the series of time epochs.

16. The method of claim 15, wherein generating the set of cross-correlation matrices comprises populating each cross-correlation matrix with a respective subset of the calculated pairwise cross-correlations.

17. A system comprising:
a data processor device;
computer memory; and
an aquatic conditions optimization management system, executable by the data processor device to:
identify a collection of aquatic data, wherein the collection of data comprises data generated by a plurality of different aquatic sensors and describes a plurality of conditions within a particular aquatic environment;
generate a set of cross-correlation matrices from the collection of aquatic data;
provide the set of cross-correlation matrices as an input to one or more unsupervised machine learning algorithms; and
determine one or more optimum conditions for the particular aquatic environment based on a result of the one or more unsupervised machine learning algorithms.

18. The system of claim 17, further comprising one or more of the plurality of aquatic sensors.

19. The system of claim 18, further comprising a gateway to communicate with the plurality of aquatic sensors and receive data in the collection of data.

20. The system of claim 17, wherein the one or more unsupervised machine learning algorithms comprises one of a neural network to perform a Bayesian unsupervised machine learning algorithm or a recursive state estimation.
